(19) United States
(12) Patent Application Publication
(10) Pub. No.: US 2026/0181757 A1
(43) Pub. Date: Jun. 25, 2026

(54) LIGHTING APPARATUS

(71) Applicant: LEEDARSON LIGHTING CO.,LTD., Zhangzhou (CN)

(72) Inventors: Yusheng Lin, Zhangzhou (CN); Shuilong Tan, Zhangzhou (CN); Xiaowei Chen, Zhangzhou (CN); Yankun Li, Zhangzhou (CN); Kaibin Qiu, Zhangzhou (CN)

(21) Appl. No.: 19/536,219

(22) Filed: Feb. 11, 2026

Related U.S. Application Data
(63) Continuation-in-part of application No. 18/218,005, filed on Jul. 3, 2023.

(30) Foreign Application Priority Data
Dec. 29, 2025 (CN) 2025227926799

(51) Int. Cl. H05B 47/16; H05B 45/10

(52) U.S. Cl. CPC H05B 47/16; H05B 45/10

(57) ABSTRACT

A lighting apparatus includes a light source, a power module, a controller, a data input module and a signal processing unit. The light source includes multiple types of LED modules. The power module converts an AC power to a DC power. The controller generating multiple driving currents supplied to the LED modules. The data input module is coupled to the controller. The data input module receives input data to be transmitted. The signal processing unit is coupled to the data input module to process the input data into multiple data streams corresponding to the plurality of transmit antennas. Each transmit antenna transmits the corresponding data stream independently.

### RELATED APPLICATION

The present application is a continuation-in-part of U.S. patent application Ser. No. 18/218,005.

### FIELD

The present invention is related to a lighting apparatus, and more particularly related to a lighting apparatus with flexible network connection.

### BACKGROUND

LED (Light-Emitting Diode) light devices have gained significant popularity and widespread usage in today's life due to several compelling advantages. Firstly, LED lights are highly energy-efficient. They consume significantly less energy compared to traditional incandescent or fluorescent lights, resulting in reduced electricity bills and lower environmental impact. The energy efficiency of LEDs is due to their ability to convert a higher percentage of electrical energy into visible light, while minimizing heat generation.

Secondly, LED light devices have an exceptionally long lifespan. They can last up to times longer than traditional bulbs, reducing the frequency of replacements and associated maintenance costs. This longevity is attributed to the absence of filaments or gases that can degrade over time. As a result, LED lights are particularly favored for applications where long-lasting illumination is crucial, such as street lighting, automotive lighting, and commercial signage.

Thirdly, LEDs offer superior durability and robustness. They are resistant to shocks, vibrations, and extreme temperature variations, making them suitable for both indoor and outdoor applications. LED lights are also compact in size, allowing for versatile installation options and integration into various products, ranging from smartphones and televisions to automotive headlights and decorative lighting fixtures.

Furthermore, LED light devices provide enhanced lighting control and flexibility. They can be dimmed easily, allowing users to adjust the brightness to their desired level, creating the right ambiance for different settings. Additionally, LEDs offer instant illumination with no warm-up time, unlike traditional bulbs that require time to reach full brightness. This instant-on feature is advantageous in applications where immediate lighting is required, such as traffic signals and emergency lighting.

Moreover, LED lights are environmentally friendly. Unlike fluorescent lights, they do not contain toxic substances like mercury, which can be harmful to human health and the environment. LED technology is considered more sustainable due to its energy efficiency, longevity, and recyclability. As a result, LED light devices contribute to reducing carbon emissions and minimizing the ecological footprint associated with lighting.

Lastly, LED light devices provide a wide range of color options and excellent color rendering capabilities. LEDs can produce a broad spectrum of colors, including vibrant and saturated hues, allowing for creative and customized lighting designs. Additionally, LEDs offer high color rendering index (CRI), ensuring that objects appear more natural and accurate under their illumination. This makes LED lights suitable for applications where color quality and aesthetics are important, such as retail displays, art galleries, and photography studios.

In summary, LED light devices are widely used in today's life due to their energy efficiency, long lifespan, durability, lighting control, environmental friendliness, and versatile color options. As technology continues to advance, LEDs are expected to further revolutionize the lighting industry, leading to increased adoption and innovative applications across various sectors.

Connectivity plays a crucial role in today's electronic world, where devices can communicate efficiently and generate multiplied effects compared to standalone devices. The ability of devices to connect and share information opens up a wide range of possibilities and benefits.

Firstly, connectivity enables seamless communication and data exchange between devices. When devices can communicate with each other, they can work together synergistically, leading to enhanced functionality and productivity. For example, in a smart home ecosystem, connected devices such as thermostats, lights, and security systems can collaborate to create an automated and personalized living environment, optimizing energy usage and providing convenience to the occupants.

Secondly, connectivity facilitates the concept of the Internet of Things (IoT), where everyday objects are interconnected and can share data. This connectivity empowers devices to gather and analyze information, enabling data-driven insights and decision-making. IoT devices can provide valuable real-time data for various applications, ranging from smart cities and industrial automation to healthcare monitoring and agriculture. The ability to collect and exchange data among devices improves efficiency, enables predictive maintenance, and enhances overall system performance.

Furthermore, connectivity brings more flexibility and convenience to our lives. With interconnected devices, individuals can access and control various functions remotely, providing convenience and comfort. For example, through a smartphone app, one can adjust the temperature of their home, monitor security cameras, or even remotely start their car. Connectivity also enables seamless integration across platforms and services, allowing users to access and manage their data and devices across different applications and ecosystems.

Lastly, connectivity fosters collaboration and innovation. When devices can communicate efficiently, they can form networks or ecosystems, encouraging collaboration between different manufacturers and developers. This collaborative approach leads to the creation of new services, applications, and business models. For instance, the integration of smart devices, cloud computing, and artificial intelligence has given rise to innovative services like virtual assistants, smart transportation systems, and personalized healthcare solutions.

In summary, connectivity in today's electronic world brings about multiplied effects when devices can communicate efficiently. It enables seamless communication, data exchange, and collaboration between devices, leading to enhanced functionality, productivity, and innovation. Furthermore, connectivity offers flexibility, convenience, and the potential for creating interconnected ecosystems that can transform various aspects of our lives, from homes and cities to industries and healthcare.

There are various types of lighting apparatuses. When cost and light efficiency of LED have shown great effect compared with traditional lighting devices, people look for even better light output. It is important to recognize factors that can bring more satisfaction and light quality and flexibility.

Light devices are widely used and most time, they are disposed on ceiling or wall or other stationary platforms. It is not easy to install such devices, because users may also need to install control units like wall switches.

It is beneficial if such light devices may have more functions to enhance living of people who use the light devices.

### SUMMARY

In some embodiments, a lighting apparatus includes a light source, a power module, a controller, a data input module and a signal processing unit.

The light source includes multiple types of LED modules.

The power module converts an AC power to a DC power.

The controller generating multiple driving currents supplied to the LED modules.

The data input module is coupled to the controller.

The data input module receives input data to be transmitted.

The signal processing unit is coupled to the data input module to process the input data into multiple data streams corresponding to the plurality of transmit antennas.

Each transmit antenna transmits the corresponding data stream independently.

In some embodiments, the input data are generated by the controller according to transmitted data of an electronic device connected to the controller.

In some embodiments, the electronic device is coupled to the controller via a second network with a different protocol from a first network used by the plurality of antennas.

In some embodiments, there are multiple electronic devices wirelessly connected to the signal processing unit to share the plurality of antennas to transmit data of the multiple electronic devices.

In some embodiments, the electronic device is coupled with a same housing used for disposing the light source.

The control device adjusts the light source for the electronic device to operate normally.

In some embodiments, the electronic device is a camera device.

Recorded video of the camera device is encoded by the signal processing unit and sent to an external device over the Internet via the plurality of antennas.

In some embodiments, the electronic device communicates with an external device over Internet via the plurality of multiple antennas.

In some embodiments, the signal processing unit and the plurality of antennas shared with the electronic device.

The electronic device disables another signal processing unit of the external device for routing output data of the electronic device to the signal processing unit of the lighting apparatus via the second network.

In some embodiments, the electronic device also has a light source for providing illumination together with the lighting apparatus.

In some embodiments, the second network is an optical modulation network.

Data transmission between the lighting apparatus and the electronic device is modulated over an emitted light of the electronic device.

In some embodiments, the electronic device is a sensor for collecting ambient information aside the lighting apparatus.

The lighting apparatus is fixed to a stationary platform.

In some embodiments, the electronic device sends a connection parameter to the controller via the second network for the controller establishes the first network for operating the plurality of antennas.

In some embodiments, the lighting apparatus may also include a precoding module.

The precoding module applies precoding to the multiple data streams to enhance signal transmission performance.

In some embodiments, the lighting apparatus may also include a channel estimation unit.

The channel estimation unit estimates channel characteristics for each transmit antenna based on a receiver feedback information received from a receiver.

In some embodiments, the lighting apparatus may also include a control module.

The control module adjusts the precoding based on the estimated channel characteristics.

In some embodiments, at least a portion of the multiple transmit antennas are disposed on different planes.

In some embodiments, at least of the plurality of the transmit antennas is a three-dimension antenna.

The three-dimension antenna includes a metal node, a first branch and a second branch.

The first branch and the second branch are connected to the metal node.

The metal node includes a feeding port for receiving signal to be emitted.

At least a portion of the first branch and at least a portion of the second branch are arranged on different planes.

In some embodiments, three dimension antenna is a multi-band antenna for transmitting signals in multiple frequency ranges.

In some embodiments, the first branch includes a first plurality of segments.

Each segment of the first plurality of segments is smaller than 1/10 of a lowest operating free-space wavelength of the multi-band antenna.

In some embodiments, the first plurality of segments includes at least ten segments.

In some embodiments, a lighting apparatus includes a rectifier module configured to receive a household AC power source and convert the household AC power source into DC power for internal use. The lighting apparatus further includes a battery for storing electrical energy, as well as a charging module electrically coupled to the rectifier module and the battery, with the charging module configured to manage energy transfer from the rectifier module to the battery. The lighting apparatus also includes a light source for producing illumination and a controller electrically coupled to the rectifier module, the battery, the charging module, and the light source. The controller detects availability of the household AC power source and selectively operates the lighting apparatus in a first operating mode when the household AC power source is available and in a second operating mode when the household AC power source is unavailable. During the first operating mode, the controller prevents the battery from supplying power to the light source in order to avoid unnecessary battery discharge. During the second operating mode, the controller allows the battery to supply power to the light source to maintain illumination during absence of the household AC power source.

In some embodiments, the household AC power source refers to electrical power delivered through fixed building wiring for residential lighting applications. Such a household AC power source commonly supplies alternating current at voltage levels suitable for direct connection to lighting devices installed in homes, apartments, bathrooms, hallways, and similar indoor environments. The household AC power source may also include power supplied in multi-unit residential buildings as well as power distributed within mixed-use buildings where lighting fixtures remain permanently connected.

In some embodiments, the rectifier module performs conversion of alternating current into direct current suitable for powering electronic components within the lighting apparatus. The rectifier module may include diode-based rectification circuits, active rectification circuits using controlled semiconductor devices, filtering components for voltage smoothing, as well as protection components for handling voltage fluctuations. Different rectifier module designs may be selected based on efficiency requirements, thermal constraints, and cost considerations.

In some embodiments, the battery serves as an energy reserve intended primarily for use during periods when the household AC power source becomes unavailable. The battery may include rechargeable electrochemical storage devices such as lithium-based batteries, nickel-based batteries, or other rechargeable battery chemistries suitable for indoor lighting applications. Battery capacity may be selected to balance operating duration, physical size, safety requirements, and expected emergency usage time.

In some embodiments, the charging module manages safe energy transfer from the rectifier module to the battery. The charging module may regulate charging current, charging voltage, and charging duration to maintain battery health. The charging module may further include protective functions such as overcharge protection, temperature monitoring, and charge termination control. Charging behavior may be optimized to keep the battery in a ready state without excessive charging stress.

In some embodiments, the light source includes one or more illumination elements configured to emit visible light when electrical power becomes available. The light source may include light emitting diodes, organic light emitting diodes, filament-based light sources, or other solid-state lighting elements. The light source may be configured for continuous illumination, intermittent illumination, or adaptive illumination depending on operating mode and control logic.

In some embodiments, the controller serves as a central control unit coordinating operation of the rectifier module, the charging module, the battery, and the light source. The controller may include a microcontroller, a microprocessor, dedicated logic circuitry, or programmable control hardware. The controller executes control logic based on detected power conditions and internal state information to manage energy usage efficiently.

In some embodiments, detection of availability of the household AC power source occurs through voltage sensing, current sensing, signal isolation circuits, or other power detection mechanisms. The controller may continuously monitor the presence of the household AC power source to enable rapid transition between operating modes. Detection accuracy ensures correct selection of operating mode without false transitions.

In some embodiments, the first operating mode prioritizes direct operation from the household AC power source while preserving battery energy. During the first operating mode, prevention of battery discharge ensures stored energy remains fully available for later emergency use. This operating strategy improves reliability during unexpected power interruptions and reduces unnecessary battery wear.

In some embodiments, the second operating mode activates automatically upon loss of the household AC power source. During the second operating mode, the battery supplies power to the light source to provide continued illumination. This operating behavior allows the lighting apparatus to function as an emergency lighting device without requiring user intervention.

In some embodiments, selective operation between the first operating mode and the second operating mode provides functional behavior similar to an uninterruptible power supply while remaining integrated within a lighting apparatus. Energy management through mode-based control extends usable battery life, improves safety during power outages, and enhances overall user experience in residential lighting environments.

In some embodiments, the lighting apparatus includes a main light source and an auxiliary light source as separate illumination elements within the same lighting system. The main light source is intended for primary illumination tasks such as grooming, cleaning, reading, and general room lighting. The auxiliary light source is intended for supplemental illumination tasks such as nighttime guidance, low-brightness visibility, and emergency lighting during power interruptions.

In some embodiments, the main light source and the auxiliary light source are physically distinct light-emitting structures. The main light source may occupy a larger area within a lighting fixture, while the auxiliary light source may occupy a smaller area positioned to provide directional or localized illumination. Physical separation allows independent electrical control and enables different operating behaviors under different power conditions.

In some embodiments, the main light source consumes more electrical power than the auxiliary light source during operation. Higher power consumption may result from higher brightness output, larger numbers of light-emitting elements, wider illumination coverage, higher current drive levels, or combinations of these factors. Increased power consumption makes the main light source less suitable for extended operation using stored battery energy.

In some embodiments, the auxiliary light source consumes less electrical power than the main light source to support longer operating time when powered by the battery. Reduced power consumption may result from lower brightness, fewer light-emitting elements, reduced current drive, or simplified optical output. Lower power consumption enables the auxiliary light source to provide meaningful illumination while preserving battery capacity during extended power outages.

In some embodiments, the controller disables the main light source during the second operating mode when the household AC power source becomes unavailable. Disabling the main light source prevents rapid battery depletion caused by high power demand. This operating behavior ensures battery energy remains available for essential illumination rather than being consumed by high-brightness lighting.

In some embodiments, the controller enables the auxiliary light source during the second operating mode to provide illumination using battery power. The auxiliary light source provides sufficient visibility for safe movement, orientation, and basic tasks during periods without household AC power. The auxiliary light source operates as an emergency illumination element optimized for energy efficiency.

In some embodiments, the controller enables the main light source during the first operating mode when the household AC power source remains available. Activation of the main light source during the first operating mode allows full-brightness illumination without concern for battery depletion. Battery energy remains preserved during normal operation when external power remains present.

In some embodiments, separation of operating behavior between the main light source and the auxiliary light source creates functional isolation between normal lighting operation and emergency lighting operation. Functional isolation prevents overlap of high-power illumination and battery-powered operation. This separation improves predictability, reliability, and energy efficiency of the lighting apparatus.

In some embodiments, the main light source includes adjustable color temperature capability, adjustable brightness capability, or both, supporting user comfort and task-specific lighting needs during normal operation. The auxiliary light source may use a fixed color temperature and fixed brightness optimized for visibility rather than ambiance. Distinct design goals for the main light source and the auxiliary light source enhance overall system versatility.

In some embodiments, inclusion of both the main light source and the auxiliary light source within a single lighting apparatus enables seamless transition between normal lighting conditions and emergency lighting conditions without requiring separate fixtures. The lighting apparatus provides continuous usability across varying power availability scenarios while preserving battery energy for periods when battery power becomes essential.

In some embodiments, the lighting apparatus uses the household AC power source to charge the battery during the first operating mode. Energy from the household AC power source flows through the rectifier module and into the charging module, with the charging module regulating energy transfer into the battery. This charging behavior ensures stored energy remains available for later use during power interruptions.

In some embodiments, charging of the battery during the first operating mode occurs concurrently with normal illumination operation. The lighting apparatus continues to operate the main light source using external power while the charging module replenishes battery capacity. Battery charging during normal operation avoids reliance on battery energy for lighting functions.

In some embodiments, electrical blocking of battery discharge occurs during the first operating mode. Electrical blocking may be achieved through switching elements, power management circuits, or control logic implemented by the controller. Blocking battery discharge prevents unintended battery drain caused by internal leakage paths, sensing circuits, or auxiliary loads.

In some embodiments, prevention of battery discharge during the first operating mode extends battery service life. Reduced cycling minimizes chemical degradation within the battery. Maintaining higher average battery charge level improves reliability during emergency use scenarios.

In some embodiments, the auxiliary light source operates at a lower brightness level than the main light source. Lower brightness output reduces electrical current demand and thermal generation. Reduced brightness supports longer operating duration when powered by the battery during the second operating mode.

In some embodiments, lower brightness of the auxiliary light source remains sufficient for human orientation and safety. Illumination provided by the auxiliary light source allows safe movement, obstacle avoidance, and basic visibility during nighttime or power outage conditions. The auxiliary light source prioritizes function over visual ambiance.

In some embodiments, the auxiliary light source includes light emitting elements selected for high luminous efficiency. High luminous efficiency converts a greater proportion of electrical energy into visible light. Improved efficiency further extends battery-powered illumination duration.

In some embodiments, the lighting apparatus includes a passive infrared motion sensor electrically coupled to the controller. The passive infrared motion sensor detects changes in infrared radiation associated with human movement. Detection capability enables responsive illumination behavior without continuous light operation.

In some embodiments, coupling between the passive infrared motion sensor and the controller allows selective activation of illumination functions. The controller receives motion detection signals and determines whether illumination activation conditions have been satisfied. Motion-based activation reduces unnecessary energy usage during periods without human presence.

In some embodiments, integration of the passive infrared motion sensor with battery-powered operation enhances overall system efficiency. Illumination occurs only when human activity exists in the illuminated area. Energy stored in the battery remains preserved during idle periods without detected motion, further extending emergency lighting availability.

In some embodiments, the lighting apparatus activates the auxiliary light source during the second operating mode only after detection of human presence by the passive infrared motion sensor. This operating behavior ensures illumination occurs in response to actual user activity rather than continuous lighting. Controlled activation reduces unnecessary battery consumption during extended periods without movement.

In some embodiments, detection of human presence occurs when the passive infrared motion sensor identifies changes in infrared radiation associated with movement of a human body. Such detection enables responsive illumination behavior suitable for nighttime use, emergency scenarios, and low-visibility environments. Motion-based activation improves user convenience while conserving stored energy.

In some embodiments, the controller initiates illumination of the auxiliary light source only after a valid motion signal has been received. The controller evaluates motion detection input before enabling electrical power delivery to the auxiliary light source. Evaluation of motion input avoids illumination triggered by electrical noise or transient environmental changes.

In some embodiments, the controller turns off the auxiliary light source after expiration of a preset delay following detection of human presence. The preset delay defines a duration during which illumination remains active after motion detection ceases. Automatic turn-off prevents prolonged illumination after human activity ends.

In some embodiments, the preset delay is configurable through internal programming, component selection, or user configuration interfaces. Different preset delay values support different usage environments such as hallways, bathrooms, stairways, or bedrooms. Adjustable delay timing balances user comfort and battery conservation.

In some embodiments, the lighting apparatus includes a light sensor electrically coupled to the controller. The light sensor detects ambient light conditions surrounding the lighting apparatus. Ambient light detection enables context-aware illumination behavior.

In some embodiments, the controller enables the auxiliary light source during the second operating mode only when ambient light detected by the light sensor falls below a preset threshold and human presence has been detected. Combined evaluation of ambient light level and motion detection prevents illumination during daylight conditions. This combined logic further reduces unnecessary battery discharge.

In some embodiments, the preset ambient light threshold is selected to represent low-light conditions appropriate for auxiliary illumination. Threshold selection may vary based on installation location, user preference, or regulatory guidelines. Proper threshold selection ensures illumination activates only when visual assistance becomes necessary.

In some embodiments, the lighting apparatus includes a user-operable mode switch electrically coupled to the controller. The user-operable mode switch allows manual selection of operating behaviors. Manual input capability provides flexibility beyond automatic control logic.

In some embodiments, the user-operable mode switch enables adjustment of lighting behavior during battery-powered operation. User selection allows customization of illumination response based on personal preference, expected outage duration, or environmental conditions. User control enhances adaptability of the lighting apparatus across different use scenarios.

In some embodiments, the user-operable mode switch allows selection between a first battery supply level and a second battery supply level during the second operating mode. Selection of different battery supply levels enables adjustment of illumination behavior during battery-powered operation. Mode selection supports adaptation to different emergency conditions.

In some embodiments, the first battery supply level provides a higher output current to the auxiliary light source. Higher output current results in increased brightness from the auxiliary light source. Increased brightness supports situations requiring stronger illumination such as navigation across larger spaces or performance of short-duration tasks.

In some embodiments, higher output current consumption corresponds to faster battery energy usage. Faster energy usage remains acceptable during brief power interruptions where strong illumination takes priority. Selection of the first battery supply level prioritizes visibility over extended operating duration.

In some embodiments, the second battery supply level provides a lower output current to the auxiliary light source. Lower output current results in reduced brightness from the auxiliary light source. Reduced brightness lowers energy consumption during battery-powered operation.

In some embodiments, reduced output current extends operating duration of the battery during the second operating mode. Extended operating duration improves reliability during prolonged power outages. Battery preservation becomes critical during emergency conditions with uncertain restoration time.

In some embodiments, the second battery supply level supports overnight illumination needs without excessive battery depletion. Reduced illumination remains sufficient for orientation, safety, and basic navigation. Extended operation enhances user confidence during extended outages.

In some embodiments, switching between the first battery supply level and the second battery supply level occurs through manual user input. Manual selection provides direct control over illumination behavior. User input allows immediate response to changing environmental conditions.

In some embodiments, switching between battery supply levels occurs without interrupting illumination output. Seamless transition avoids sudden changes in visibility. Smooth switching improves user experience during emergency lighting operation.

In some embodiments, implementation of multiple battery supply levels provides flexibility across a wide range of power outage scenarios. Short outages benefit from higher brightness selection. Long outages benefit from energy conservation selection.

In some embodiments, inclusion of selectable battery supply levels enhances overall energy management strategy within the lighting apparatus. Controlled energy delivery balances illumination quality and battery endurance. Adaptive battery supply behavior contributes to reliable emergency lighting performance.

In some embodiments, the controller monitors a battery charge level during operation of the lighting apparatus. Battery charge level monitoring provides information regarding remaining stored energy available for emergency illumination. Continuous awareness of battery condition supports reliable operation during power interruption events.

In some embodiments, the controller activates a warning indicator when the battery charge level falls below a preset threshold. Activation of the warning indicator alerts a user to reduced available energy. Early warning enables timely charging actions during periods when household AC power remains available.

In some embodiments, the warning indicator includes a visual indicator integrated into the lighting apparatus. Visual indicators may include light-emitting elements, display segments, or symbolic illumination patterns visible during normal observation of the lighting apparatus. Visual feedback allows immediate recognition of battery condition without additional equipment.

In some embodiments, the visual indicator communicates battery status through color changes, brightness variation, blinking patterns, or steady illumination states. Different visual presentations correspond to different battery charge levels. Clear visual signaling improves user awareness and reduces risk of unexpected battery depletion.

In some embodiments, the controller operates the lighting apparatus in a third operating mode dedicated to battery conditioning. Battery conditioning supports long-term battery health during extended installation lifetimes. Periodic conditioning maintains stable electrochemical behavior within the battery.

In some embodiments, the third operating mode initiates controlled partial discharge of the battery followed by controlled recharging. Partial discharge avoids continuous full-charge storage conditions. Controlled recharging restores energy capacity after discharge completion.

In some embodiments, partial discharge during the third operating mode limits battery discharge to no more than half of a rated battery capacity. Limiting discharge depth preserves sufficient remaining energy for emergency lighting availability. Shallow discharge avoids excessive stress on battery chemistry.

In some embodiments, controlled discharge depth balances battery maintenance with readiness for sudden power interruption. Preservation of emergency reserve energy ensures immediate illumination capability even during battery conditioning activity. Energy management remains aligned with safety requirements.

In some embodiments, subsequent recharging during the third operating mode restores the battery to an optimal charge level. Restoration prepares the battery for future emergency use. Recharging parameters may follow manufacturer-recommended charging profiles.

In some embodiments, inclusion of battery charge monitoring, warning indication, and controlled conditioning enhances long-term reliability of the lighting apparatus. Combined management features reduce risk of battery failure during critical moments. Integrated battery health management supports dependable emergency lighting performance across extended service periods.

### BRIEF DESCRIPTION OF DRAWINGS

FIG. 1 illustrates a lighting apparatus embodiment.

FIG. 2 illustrates a circuit diagram of the lighting apparatus embodiment.

FIG. 3 shows another lighting apparatus embodiment.

FIG. 4 shows a different aspect of a lighting apparatus example.

FIG. 5 shows another lighting apparatus embodiment.

FIG. 6 shows a three-dimension antenna example.

FIG. 7 shows another three-dimension antenna example.

FIG. 8 shows an antenna with multiple segments.

FIG. 9 shows another antenna with different number of segments.

FIG. 10 shows another antenna with different number of segments.

FIG. 11 shows another antenna with different number of segments.

FIG. 12 is another embodiment of a lighting apparatus.

FIG. 13 is a schematic diagram illustrating a circuit structure of an LED lamp control circuit according to an embodiment.

FIG. 14 is a schematic diagram illustrating a circuit structure of a controller module according to an embodiment.

FIG. 15 is a circuit principle diagram illustrating an AC detection unit according to an embodiment.

FIG. 16 is a partial circuit principle diagram illustrating a first control unit according to an embodiment.

FIG. 17 is a circuit principle diagram illustrating a first power supply unit according to an embodiment.

FIG. 18 is a schematic diagram illustrating a circuit structure of a charging module according to an embodiment.

FIG. 19 is a circuit principle diagram illustrating a charging module according to an embodiment.

FIG. 20 is a schematic diagram illustrating a circuit structure of a first power module according to an embodiment.

FIG. 21A is a circuit principle diagram illustrating a first portion of a rectifier module and a first power module according to an embodiment.

FIG. 21B is a circuit principle diagram illustrating a second portion of a rectifier module and a first power module according to an embodiment.

FIG. 22 is a circuit principle diagram illustrating a sensing module according to an embodiment.

### DETAILED DESCRIPTION

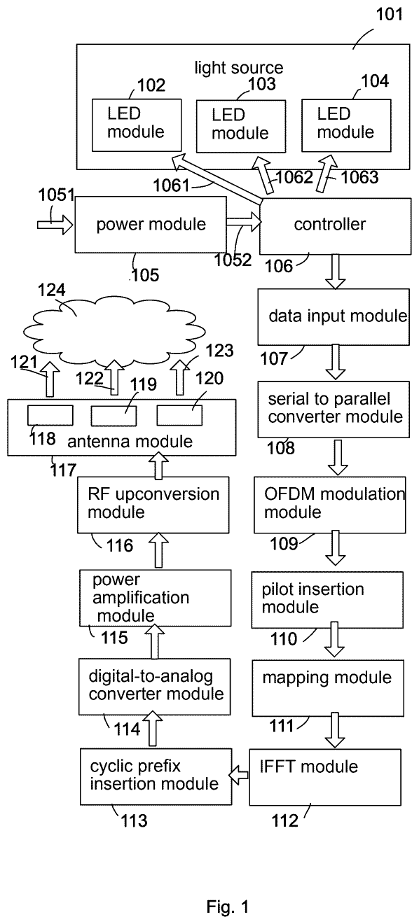

In FIG. 1, a lighting apparatus includes a light source 101, a power module 105, a controller 106, a data input module 107, a serial-to-parallel converter module 108, an orthogonal frequency division multiplexing (OFDM) modulation module 109, a radio frequency (RF) upconversion module 116 and an antenna module 117.

The light source 101 includes multiple types of LED modules 102, 103, 104. These LED modules 102, 103, 104 may include same LED chips but covered with different fluorescent layers for generating lights of different light parameters like color temperatures, colors. By controlling driving currents and/or timing for supplying power may adjust a mixed light parameter meeting users need. Users may use a manual switch, a remote control or other devices coupled to the controller 106 to adjust the required light parameter.

The power module 105 converts an AC power 1051 to a DC power 1052.

The controller 106 generates multiple driving currents 1061, 1062, 1063 supplied to the LED modules 102, 103, 104.

There are various ways to control the driving currents, e.g. PWM. PWM (Pulse Width Modulation) may be used to control the driving currents supplied to different LED modules, allowing us to mix and achieve desired light parameters like color temperature. It works by precisely adjusting the width and frequency of electrical pulses sent to the LED modules. By varying the pulse width, we can control the intensity of the current flowing through the LEDs.

With PWM, we can mix LED modules that emit different colors or have different color temperatures. By independently adjusting the driving currents for each module, we can create seamless transitions between warm and cool tones of light. This level of control gives us the ability to set the perfect lighting ambiance for any space or occasion.

One of the advantages of PWM is its flexibility. By controlling the driving currents of each LED module, we can create dynamic lighting effects. This is particularly useful for architectural lighting, stage productions, or visual displays where captivating and immersive lighting arrangements are desired.

PWM technology also brings efficiency benefits. By precisely adjusting the driving currents, we can optimize power consumption without compromising on lighting quality. This leads to energy savings and extends the lifespan of the LED modules, reducing the need for frequent replacements and maintenance.

In summary, PWM is a powerful technology that enables us to control the driving currents supplied to LED modules for mixing desired light parameters. It provides precise control over intensity and color temperature, allowing for customizable lighting experiences. With PWM, we can achieve dynamic lighting effects, save energy, and create captivating visual environments.

The data input module 107 is coupled to the controller 106. The data input module 107 receives input data to be transmitted.

The data input module 107 is a crucial component in an OFDM (Orthogonal Frequency Division Multiplexing) system, responsible for receiving and handling the input data to be transmitted. Its role is to process and prepare the data for modulation and subsequent transmission over the wireless channel.

In the OFDM system, the data input module 107 typically interfaces with external devices or systems that generate or provide the data to be transmitted. This can include sources such as audio/video devices, data storage systems, or network connections. The module receives the input data in a suitable format, which could be digital data streams, audio/video signals, or other types of information.

Upon receiving the input data, the module may perform various tasks to prepare it for modulation. These tasks can include data formatting, error correction encoding, or data compression, depending on the specific requirements and characteristics of the data transmission system. The data input module ensures that the input data is in a suitable format and ready for further processing.

Additionally, the data input module may incorporate protocols or algorithms to handle synchronization and timing aspects of the input data. In an OFDM system, precise timing and synchronization are critical to ensure proper demodulation and reception of the transmitted data. The module may synchronize the input data streams with the system clock or apply synchronization techniques to align the data with the OFDM symbols and subcarriers.

Overall, the data input module in an OFDM system serves as the interface between the external data sources and the internal processing components. It handles tasks such as data formatting, error correction encoding, compression, and synchronization, ensuring that the input data is properly prepared for modulation and subsequent transmission. The efficiency and accuracy of the data input module contribute to the overall performance and reliability of the OFDM communication system.

The serial-to-parallel converter module 108 converts the input data into multiple parallel data streams.

The serial-to-parallel converter module is a crucial component in an OFDM (Orthogonal Frequency Division Multiplexing) system that plays a vital role in preparing the input data for modulation and transmission. As the name suggests, this module converts the incoming serial data stream into multiple parallel data streams, which are then used for further processing and modulation.

In an OFDM system, the input data is typically received in a sequential or serial format. However, for efficient transmission using the parallel processing capabilities of OFDM, the data needs to be organized into multiple parallel streams that can be modulated onto different subcarriers simultaneously.

The serial-to-parallel converter module takes the incoming serial data stream and divides it into several parallel data streams. This conversion is achieved by assigning different portions or subsets of the input data to each parallel stream. The number of parallel streams is determined by the total number of subcarriers used in the OFDM system.

By converting the serial data stream into parallel data streams, the module enables simultaneous transmission of multiple data symbols or bits. This parallelization helps to increase the data transmission rate and overall system capacity.

Additionally, the serial-to-parallel converter module ensures synchronization and alignment of the parallel data streams with the OFDM symbol structure. Each parallel stream corresponds to a specific subcarrier and is associated with a specific frequency in the frequency domain. The module ensures that the data is properly organized and aligned with the OFDM symbol boundaries, ensuring accurate demodulation at the receiver end.

Overall, the serial-to-parallel converter module in an OFDM system is responsible for dividing the incoming serial data stream into multiple parallel data streams. This conversion allows for simultaneous transmission on different subcarriers, increasing the data transmission rate and system capacity. Additionally, the module ensures synchronization and alignment of the parallel data streams with the OFDM symbol structure, enabling accurate demodulation and reception of the transmitted data.

The orthogonal frequency division multiplexing (OFDM) modulation module 109 modulates the parallel data streams onto multiple orthogonal subcarriers.

The orthogonal frequency division multiplexing (OFDM) modulation module is a fundamental component in an OFDM system that performs crucial tasks related to the modulation of parallel data streams onto subcarriers for transmission. Its role is to convert the parallel data streams into the frequency domain representation required for efficient transmission over the wireless channel.

Firstly, the OFDM modulation module takes the parallel data streams received from the serial-to-parallel converter module and applies a process called inverse fast Fourier transform (IFFT). The IFFT converts the data from the time-domain to the frequency-domain representation. This transformation is essential for dividing the available frequency spectrum into orthogonal subcarriers, which carry the parallel data streams.

Once the data is in the frequency domain, the OFDM modulation module performs a crucial step known as subcarrier modulation. Each subcarrier is modulated independently with the corresponding parallel data stream using techniques such as phase-shift keying (PSK), quadrature amplitude modulation (QAM), or other modulation schemes. This modulation process encodes the data onto the subcarriers, readying it for transmission.

The OFDM modulation module also incorporates techniques to mitigate interference between subcarriers. It ensures that the subcarriers are carefully spaced to achieve orthogonality, meaning they do not overlap or interfere with each other.

Orthogonality is crucial to prevent inter-symbol interference and ensure that the data streams can be accurately demodulated at the receiver end.

Furthermore, the module may incorporate additional processing to accommodate system requirements and channel conditions. This can include pilot signal insertion, which involves inserting known reference symbols at specific subcarrier positions. The pilot signals aid in channel estimation, equalization, and synchronization at the receiver, enhancing the overall system performance.

Additionally, the OFDM modulation module handles the mapping of the modulated subcarriers onto specific time-frequency resource blocks. These resource blocks define the allocation of subcarriers and symbol durations, allowing for efficient utilization of the available frequency spectrum.

In summary, the OFDM modulation module in an OFDM system is responsible for converting parallel data streams into the frequency domain, modulating the data onto orthogonal subcarriers, mitigating interference, and mapping the modulated subcarriers onto time-frequency resource blocks. It plays a vital role in preparing the data for transmission, ensuring efficient utilization of the available frequency spectrum and enabling accurate demodulation at the receiver end.

Orthogonality plays a critical role in orthogonal frequency division multiplexing (OFDM) systems, offering significant advantages in signal modulation and preventing interference between signals when transmitted through the air.

In an OFDM system, the subcarriers used for modulation are carefully spaced to be orthogonal to each other. This means that the subcarriers have no overlap and do not interfere with one another. The orthogonality property enables the simultaneous transmission of multiple subcarriers, each carrying independent data streams. This allows for efficient utilization of the frequency spectrum and significantly increases the data transmission capacity of the system.

Orthogonality is crucial in signal modulation because it simplifies the demodulation process at the receiver. When the subcarriers are orthogonal, they can be easily separated at the receiver end using a process called the fast Fourier transform (FFT). The orthogonality ensures that each subcarrier can be demodulated independently, without interference from other subcarriers. This simplifies the signal demodulation process and enables accurate recovery of the original data streams.

Furthermore, orthogonality helps mitigate the effects of multipath interference in wireless channels. In wireless communication, signals can undergo reflections, scattering, and other propagation phenomena that cause the signals to take multiple paths and arrive at the receiver with varying delays. The orthogonality of subcarriers in OFDM helps in dealing with multipath interference by separating the delayed signals in the frequency domain. This allows the receiver to individually equalize and combine the received subcarriers, effectively mitigating the negative effects of multipath fading and improving overall system performance.

The orthogonality property also contributes to the resilience of OFDM systems against narrowband interference. Narrowband signals that fall outside the allocated subcarrier frequencies do not disrupt the transmission of other subcarriers due to their orthogonality. Interference from neighboring frequency bands or adjacent channels can be effectively rejected by the receiver, ensuring robust and reliable data transmission.

Moreover, the orthogonality of subcarriers allows for better spectral containment. Since the subcarriers do not overlap, the sidebands of each subcarrier are confined to their allocated frequency range. This reduces spectral leakage and improves spectral efficiency, enabling more efficient utilization of the available frequency spectrum.

Overall, orthogonality is a fundamental characteristic of OFDM systems that ensures efficient signal modulation, robustness against interference, and improved spectral containment. It enables simultaneous transmission of multiple independent data streams while simplifying the demodulation process at the receiver end. Orthogonality plays a crucial role in the success and widespread adoption of OFDM in various wireless communication standards, such as Wi-Fi and cellular networks.

To provide an easy-to-understand example of orthogonal signals, let's consider two people standing on opposite sides of a large field. Each person has a flag that they can wave to communicate with each other.

Now, imagine that the two people agree to use orthogonal waving patterns. Person A decides to wave their flag up and down, while Person B chooses to wave their flag left and right. These waving patterns are orthogonal because they are perpendicular to each other.

When Person A starts waving their flag up and down, Person B can easily distinguish and recognize this waving pattern as separate from their own left-to-right waving. Similarly, when Person B waves their flag left and right, Person A can clearly distinguish this motion from their own up-and-down waving. Despite both people waving their flags simultaneously, there is no confusion or interference between their signals because they have chosen orthogonal waving patterns.

In this example, the waving patterns represent the orthogonal signals in an OFDM system. Each person's waving pattern corresponds to a subcarrier in OFDM, and the field represents the frequency spectrum available for transmission. The orthogonal waving patterns allow for simultaneous communication without interfering with each other.

This example demonstrates the importance of orthogonality in signal communication. It ensures that different signals can coexist and be easily distinguished, even when transmitted simultaneously. By applying this concept to the frequencies used in OFDM, where subcarriers are carefully chosen to be orthogonal, we can achieve efficient and reliable communication with minimal interference between the signals.

Each subcarrier is associated with a specific frequency and carries a portion of the parallel data streams.

In orthogonal frequency division multiplexing (OFDM) systems, the transmission bandwidth is divided into multiple subcarriers, each associated with a specific frequency. This frequency allocation ensures that different subcarriers can carry independent data streams simultaneously, enabling efficient and simultaneous data transmission.

By assigning each subcarrier to a specific frequency, OFDM systems achieve a highly efficient use of the available spectrum. The subcarriers are carefully chosen to be orthogonal to each other, meaning they have no overlap and do not interfere with one another. This allows for simultaneous transmission of multiple data streams, significantly increasing the system's capacity and throughput.

Each subcarrier in an OFDM system carries a portion of the parallel data streams. This means that the total data to be transmitted is divided into smaller segments, and each segment is assigned to a different subcarrier. By dividing the data in this way, each subcarrier carries a specific subset of the overall data, allowing for parallel transmission and efficient utilization of the available bandwidth.

The allocation of data to different subcarriers is typically done using modulation techniques such as phase-shift keying (PSK) or quadrature amplitude modulation (QAM). These modulation schemes encode the data onto the subcarriers, enabling the receiver to demodulate and recover the original data streams accurately.

The specific frequency associated with each subcarrier is determined by the system's design and the available bandwidth. The number of subcarriers and their frequency spacing is carefully chosen to achieve orthogonality, ensuring that the subcarriers do not interfere with one another. This orthogonality property enables the receiver to separate and recover the individual data streams with minimal interference.

The use of specific frequencies for each subcarrier allows for selective filtering and equalization at the receiver end. By employing frequency-selective equalization techniques, the receiver can compensate for channel impairments or frequency-selective fading that may affect different subcarriers differently.

In summary, in an OFDM system, each subcarrier is associated with a specific frequency and carries a portion of the parallel data streams. This frequency allocation enables simultaneous transmission of multiple data streams, leading to efficient utilization of the available spectrum. The orthogonality of the subcarriers ensures minimal interference between them, enabling accurate demodulation and reliable data recovery at the receiver.

The radio frequency (RF) upconversion module 116 upconverts the multiple data streams to multiple desired transmission frequencies.

In an OFDM (Orthogonal Frequency Division Multiplexing) system, the radio frequency (RF) upconversion module plays a crucial role in the transmission process. Its purpose is to convert the multiple data streams, which have been modulated onto different subcarriers, to the desired transmission frequencies for wireless communication.

After the parallel data streams have undergone modulation onto subcarriers in the frequency domain, the RF upconversion module steps in to raise the frequency of these signals. Each data stream corresponds to a specific subcarrier with its own frequency. The RF upconversion module takes these modulated subcarriers and increases their frequency to the desired transmission frequencies.

By upconverting the frequency of the modulated data streams, the RF upconversion module ensures that the signals are in the appropriate frequency range for wireless transmission. This step is essential because wireless communication typically operates in specific frequency bands allocated for various applications such as Wi-Fi, cellular networks, or radio broadcasting.

The RF upconversion module achieves the frequency upconversion by utilizing techniques such as mixing or frequency multiplication. These methods involve manipulating the input signals to shift their frequency to the desired transmission frequencies while preserving the information encoded in them. This process ensures that the modulated data streams are ready for wireless transmission and can be effectively radiated through an antenna.

The upconverted signals are then passed through a power amplification stage to boost their power level to an appropriate level for transmission. This amplification is necessary to ensure that the signals can propagate over the desired range and achieve reliable communication.

The RF upconversion module's ability to convert the multiple data streams to the desired transmission frequencies is crucial for achieving successful wireless communication in an OFDM system. It ensures that the modulated signals are properly prepared and tuned for transmission in the wireless medium, allowing them to propagate through the air and be received by the intended receivers.

The RF upconversion module in an OFDM system is responsible for converting the multiple data streams, which have been modulated onto different subcarriers, to the desired transmission frequencies. This process is essential for enabling wireless communication by raising the frequency of the signals and preparing them for transmission through the air. The RF upconversion module, in combination with power amplification, ensures that the modulated data streams are ready to be radiated through an antenna and transmitted wirelessly to the intended recipients.

The antenna module includes multiple antennas configured to transmit RF signals corresponding to the multiple data streams.

In an OFDM (Orthogonal Frequency Division Multiplexing) system, the antenna module is a crucial component responsible for transmitting RF (Radio Frequency) signals corresponding to the multiple data streams. Its role is to convert the modulated data streams into electromagnetic waves and radiate them into the wireless medium.

The antenna module consists of multiple antennas that are configured to handle the transmission of the RF signals. Each antenna corresponds to a specific data stream that has been modulated onto a subcarrier. The multiple antennas work in tandem to transmit the individual RF signals associated with the parallel data streams simultaneously.

The antennas in the module are designed to efficiently radiate the RF signals into the surrounding space. They convert the electrical signals received from the RF upconversion stage into electromagnetic waves that propagate through the air. The antennas are carefully positioned and optimized to achieve desired radiation patterns, coverage, and gain for effective communication.

By utilizing multiple antennas, the OFDM system takes advantage of spatial diversity and spatial multiplexing techniques. Spatial diversity helps improve the reliability of the wireless communication by mitigating the effects of fading and interference. If one antenna experiences signal degradation, the other antennas can still transmit the RF signals, ensuring a more robust and reliable transmission.

Spatial multiplexing, on the other hand, enables the simultaneous transmission of multiple data streams using different antennas. Each antenna transmits a unique data stream, allowing for increased data rates and enhanced system performance. The receiver, equipped with a corresponding antenna configuration, can then demultiplex and extract the individual data streams from the received signals.

The antenna module's ability to transmit the RF signals corresponding to the multiple data streams is essential for the successful communication of an OFDM system. It ensures that the modulated data is effectively radiated into the wireless medium, enabling its propagation and reception by the intended receivers. The configuration and characteristics of the antennas greatly influence the system's coverage, capacity, and overall performance.

The antenna module in an OFDM system includes multiple antennas that are configured to transmit RF signals corresponding to the multiple data streams. These antennas work together to radiate the modulated data streams into the wireless medium.

By leveraging spatial diversity and spatial multiplexing, the antenna module enhances the reliability, data rates, and overall performance of the OFDM system. It plays a vital role in ensuring effective wireless transmission and reception of the modulated data streams.

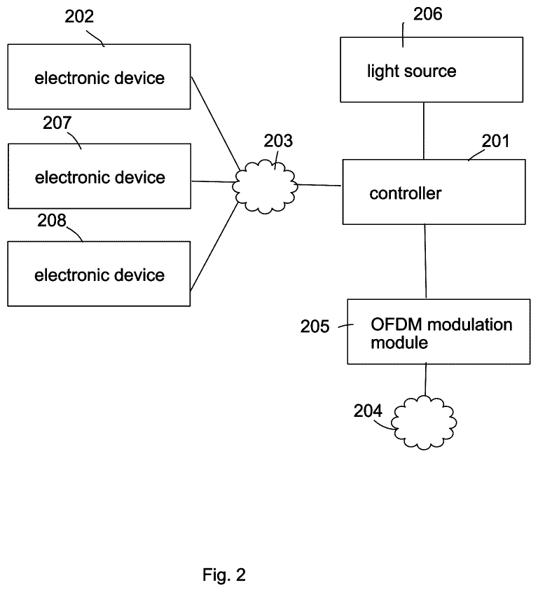

In FIG. 2, the input data are generated by the controller 201 according to transmitted data of an electronic device 202 connected to the controller 201.

In some embodiments, the electronic device 202 is coupled to the controller 201 via a second network 203 with a different protocol from a first network 204 of the OFDM modulation module 205.

For example, the first network 204 to which the OFDM modulation module 205 modulates data to signal is a 4G network that further connected to the Internet. The second network 203 may be a local short distance network like Bluetooth. The electronic device 202 may be another lighting apparatus that is disposed aside the lighting apparatus mentioned above. The electronic device 202, in some other embodiments, may be a sensor, a camera, a speaker, or any other devices that coupled to the controller 201 wirelessly or via a wire.

In some embodiments, there are multiple electronic devices 202, 207, 208 wirelessly connected to the OFDM modulation module 205 to share the OFDM modulation module 205 to transmit data of the multiple electronic devices 202, 207, 208.

In other words, the electronic devices 202, 207, 208 may connect to the Internet via 4G network like the first network 204 illustrated in FIG. 2, even they only connect to the lighting apparatus.

This is very useful particularly when the lighting apparatus is fixed to a stationary platform, like a ceiling or a wall surface. By deploying the lighting apparatus in such way, the lighting apparatus is located statically in a place, with electric supply and may be a central station for connecting more devices to enhance overall interaction.

For example, with such arrangement, not every electronic device 202 needs to have a OFDM modulation module but the electronic device 202 may still transmit data via an OFDM network.

Since the controller 201 is also coupled to the light source 206 for controlling light parameters by generating corresponding driving currents, such design simplifies overall circuit cost and makes the connection more flexible.

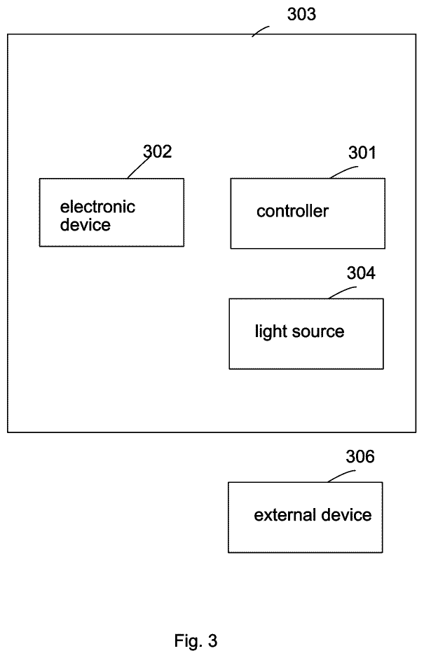

In FIG. 3, the electronic device 302 is coupled with a same housing 303 used for disposing the light source 304.

The control device 301 adjusts the light source 304 for the electronic device 302 to operate normally. For example, the electronic device 302 is a speaker or a camera device integrated with the lighting apparatus.

In elder care facility, cameras may be easily installed because they are integrated with lighting apparatus that already has an installation box to insert the lighting apparatus. The cameras may be customized to detect accident while not affecting personal privacy.

In such case, the light source provides sufficient light for the camera to function normally. The controller 301 is helpful because the light source 304 may be adjusted when the camera is determined to turn on while some events are detected, e.g. falling sounds.

In such case, even the light source 304 is originally turned off, to activate the camera and make the camera working normally, the light source 304 is turned on temporarily for capturing clear pictures to protect the elder under the lighting apparatus and the camera.

In some embodiments, the electronic device is a camera device.

Recorded video of the camera device is encoded by the OFDM modulation module and sent to an external device 306 over the Internet via the antenna module mentioned above.

In some embodiments, the electronic device 302 communicates with an external device 306 over Internet via the OFDM modulation module mentioned above.

The electronic device 302 integrated with the lighting apparatus may have its own unique identification code while the lighting apparatus has another unique identification code so that the electronic device 302 and the lighting apparatus may be located and controlled separately. Messages may be selectively sent to the lighting apparatus and/or the electronic device 302.

In some embodiments, the OFDM modulation module is shared with the electronic device.

The electronic device disables another OFDM modulation module of the external device for routing output data of the electronic device to the OFDM modulation module via the second network.

For example, in the example of FIG. 2, the electronic device 202 may be another lighting apparatus with the same structure as the lighting apparatus mentioned above. In other words, the electronic device 202 also has an OFDM modulation module and other components to communicate in the first network 204 like an 4G network to connect to the Internet.

But, the electronic device 202 may be automatically configured when the electronic device 202 detects the lighting apparatus with the OFDM modulation module 205 nearby.

In such case, the electronic device 202 automatically disables its own OFDM function but uses only its network interface for the second network 203.

Even the electronic device 202 only uses the second network 203, by help of the controller 201, the data of the electronic device 202 may still able be transmitted to the Internet by sharing the OFDM modulation module 205.

In some embodiments, the electronic device also has a light source for providing illumination together with the lighting apparatus.

In some embodiments, the second network is an optical modulation network.

In other words, the electronic device 202 may encoded its data to transmit to the controller 201 via a light modulation technology like Li-Fi. In other words, the communication is a hybrid transmission using both OFDM and optical modulation network.

Data transmission between the lighting apparatus and the electronic device is modulated over an emitted light of the electronic device.

In some embodiments, the electronic device is a sensor for collecting ambient information aside the lighting apparatus. For example, the electronic device 202 may be a temperature detector, a smoke detector, human action detector, light detector, accident warning detector and/or other various sensors.

The lighting apparatus is fixed to a stationary platform, like a wall or a ceiling.

In some embodiments, the electronic device sends a connection parameter to the controller via the second network for the controller establishes the first network for operating the OFDM modulation module.

For example, the electronic device 202 wireless connected to the controller 201 uses a Bluetooth network, a RFID data transmission or other technology to transmit connection parameters like network ID and passwords to the controller 201 to initialize the network setting of the OFDM network that the OFDM modulation module 205 and other components may need to use the first network 204.

In FIG. 1, the lighting apparatus may also include a pilot insertion module 110 configured to insert pilot symbols into the modulated parallel data streams at predetermined positions for channel estimation and equalization.

The pilot insertion module in an OFDM (Orthogonal Frequency Division Multiplexing) system performs a crucial function by inserting pilot symbols into the modulated parallel data streams at predetermined positions. These pilot symbols serve two main purposes: channel estimation and equalization.

To begin with, channel estimation involves determining the characteristics of the wireless channel through which the OFDM signals propagate. By strategically inserting pilot symbols at specific positions in the modulated data streams, the pilot insertion module provides reference points for assessing the channel's response to the transmitted signals. The receiver can then leverage these received pilot symbols to estimate the channel's frequency response, phase shifts, and other relevant properties.

The second purpose of pilot symbol insertion is equalization. The pilot symbols act as known reference points that aid in compensating for distortions and impairments introduced by the wireless channel. By inserting pilot symbols into the modulated parallel data streams, the pilot insertion module enables the receiver to accurately determine the channel's frequency response. This information is subsequently utilized to perform equalization, where appropriate adjustments are applied to the received signals, mitigating the effects of channel fading, interference, and noise.

The pilot symbols are inserted at predetermined positions within the modulated data streams, following a carefully chosen pattern. These positions are selected to facilitate accurate estimation of the channel characteristics and enable effective equalization. The responsibility of determining these positions and inserting the pilot symbols lies with the pilot insertion module.

Ultimately, by inserting pilot symbols and enabling channel estimation and equalization, the pilot insertion module enhances the robustness and reliability of the OFDM system. The reference pilot symbols provide valuable insights into the wireless channel, allowing for accurate estimation and compensation of channel-induced distortions. This, in turn, empowers the receiver to demodulate data symbols with greater precision, resulting in improved overall system performance in terms of data detection and error correction.

Pilot signals in OFDM (Orthogonal Frequency Division Multiplexing) are reference signals inserted into the transmitted signal to assist in channel estimation, equalization, and signal recovery at the receiver. They serve as known reference points that provide valuable information about the wireless channel's characteristics and aid in mitigating the effects of channel impairments.

To understand the concept of pilot signals, let's consider an analogy of a treasure hunt. Imagine you are searching for hidden treasures in a vast and unfamiliar terrain. To navigate and make progress, you periodically encounter markers or guideposts strategically placed along the way. These markers provide valuable information about your location, direction, and any obstacles you may encounter ahead.

Similarly, in an OFDM system, pilot signals act as these markers or guideposts. They are carefully inserted into the transmitted signal at predetermined positions. These positions are known and defined in advance. When the signal reaches the receiver, it encounters these pilot signals, providing reference points for various purposes.

One such purpose is channel estimation. As the signal propagates through the wireless channel, it undergoes various distortions like multipath fading, interference, and noise. By observing the received pilot signals, the receiver can estimate the channel's response to the transmitted signal. This information allows the receiver to adjust its equalization algorithms and compensate for the channel-induced distortions, enhancing the accuracy of data recovery.

Pilot signals also aid in symbol synchronization. By detecting the timing and phase of the pilot symbols, the receiver can align itself with the transmitted signal's timing and correctly demodulate the subsequent data symbols. This synchronization ensures accurate symbol recovery and minimizes errors caused by timing discrepancies.

Additionally, pilot signals play a crucial role in equalization. By knowing the transmitted pilot symbols, the receiver can compare them with the received pilot symbols and identify any changes or distortions introduced by the channel. This knowledge enables the receiver to apply equalization techniques to counteract these effects, ensuring reliable and accurate demodulation of the data symbols.

In summary, pilot signals in OFDM act as reference markers or guideposts inserted into the transmitted signal. They assist in channel estimation, symbol synchronization, and equalization at the receiver. Just as markers help navigate a treasure hunt, pilot signals provide valuable information about the wireless channel's characteristics, aiding in accurate data recovery and mitigating the effects of channel impairments.

In some embodiments, the lighting apparatus may also include a mapping module 111 and an inverse fast Fourier transform (IFFT) module 112.

The mapping module 111 maps the modulated and pilot inserted parallel data streams onto time-frequency resource blocks.

The mapping module in an OFDM (Orthogonal Frequency Division Multiplexing) system serves a crucial function by mapping the modulated and pilot-inserted parallel data streams onto time-frequency resource blocks. This module plays a vital role in organizing the data streams for efficient transmission and accurate demodulation at the receiver.

To ensure effective transmission, the mapping module assigns the modulated and pilot-inserted data streams to specific time-frequency resource blocks. These resource blocks provide a structured grid-like framework that divides the available transmission time into discrete slots and the frequency spectrum into subcarriers. By allocating the data streams to their respective positions within the time-frequency grid, the mapping module optimizes the utilization of the available bandwidth.

By mapping the data streams onto time-frequency resource blocks, the system achieves efficient utilization of the available transmission resources. The flexibility of the mapping process allows for dynamic allocation of resource blocks to different data streams, based on factors such as priority, quality of service requirements, or system configuration. This dynamic allocation ensures optimized data transmission and enhances overall system performance.

Moreover, the mapping process enables accurate demodulation at the receiver end. By organizing the data streams into time-frequency resource blocks, the receiver knows precisely where to locate and expect the different data symbols during the demodulation process. This organized mapping facilitates proper demultiplexing and accurate recovery of the individual data streams from the received signal.

Additionally, the mapping module accounts for system-specific considerations such as guard intervals. Guard intervals are inserted between successive time slots to mitigate the effects of multipath interference. The mapping module ensures that the data streams are appropriately positioned within the resource blocks, accounting for guard intervals and maintaining the required timing relationships.

In conclusion, the mapping module in an OFDM system plays a crucial role in organizing and allocating the modulated and pilot-inserted parallel data streams onto time-frequency resource blocks. This process optimizes data transmission, facilitates accurate demodulation, and enables efficient utilization of the available transmission resources. The mapping module's contribution is essential for achieving reliable and high-performance communication in OFDM systems.

The IFFT module 112 performs an inverse fast Fourier transform on the mapped time-frequency resource blocks to generate time-domain OFDM signals.

The IFFT (Inverse Fast Fourier Transform) module 112 is a fundamental component in an OFDM (Orthogonal Frequency Division Multiplexing) system that plays a crucial role in the generation of time-domain OFDM signals. This module is responsible for converting the mapped time-frequency resource blocks, which contain the data streams, back into the time domain.

To generate time-domain OFDM signals, the IFFT module 112 performs an inverse fast Fourier transform on the mapped time-frequency resource blocks. This transformation is the reverse process of the initial Fourier transform performed during modulation, where the data streams were mapped onto the subcarriers in the frequency domain.

By applying the inverse fast Fourier transform, the IFFT module 112 combines the individual subcarriers, each carrying a portion of the modulated data streams, and reconstructs the time-domain OFDM signals. This conversion allows for the representation of the data in the time domain, which is suitable for transmission and reception.

The IFFT process essentially converts the frequency-domain representations of the data streams, which were distributed across the subcarriers, back into their original time-domain waveforms. This reconstruction enables the generation of a composite time-domain signal that encapsulates all the individual data streams.

The resulting time-domain OFDM signals from the IFFT module 112 are ready for transmission over the wireless channel. These signals represent the parallel data streams that were initially modulated and mapped onto the time-frequency resource blocks. They are now in a format that can be transmitted as electrical signals or electromagnetic waves, propagating through the air to reach the intended receiver.

In summary, the IFFT module 112 in an OFDM system performs an inverse fast Fourier transform on the mapped time-frequency resource blocks. This transformation converts the frequency-domain representations of the individual data streams back into their original time-domain waveforms, generating time-domain OFDM signals. These signals are then ready for transmission over the wireless channel, carrying the parallel data streams to be received and demodulated at the receiver end.

In some embodiments, the lighting apparatus may also include a cyclic prefix insertion module 113 and a digital-to-analog converter module 114.

The cyclic prefix insertion module 113 inserts a cyclic prefix to the time-domain OFDM signal to mitigate inter-symbol interference.

The cyclic prefix insertion module 113 plays a vital role in mitigating inter-symbol interference in an OFDM (Orthogonal Frequency Division Multiplexing) system. It accomplishes this by inserting a cyclic prefix to the time-domain OFDM signal before transmission.

Inter-symbol interference can occur when the transmitted signal encounters multipath propagation or other forms of channel distortion. It causes overlapping of symbols in the time domain, leading to errors in data reception. The cyclic prefix is a copy of the end portion of the OFDM symbol that is inserted at the beginning of each symbol.

By inserting a cyclic prefix, the cyclic prefix insertion module 113 creates a guard interval between symbols. This guard interval acts as a buffer, separating the symbols and preventing them from overlapping. It allows the receiver to isolate and properly demodulate each symbol without interference from the previous or subsequent symbols.

The length of the cyclic prefix is chosen to be longer than the expected delay spread of the channel, accounting for the maximum delay spread encountered in the wireless environment. This ensures that even if the transmitted signals experience different delays or reflections, the cyclic prefix is sufficiently long to accommodate any potential delay spread and prevent inter-symbol interference.

The cyclic prefix insertion module 113 adds the cyclic prefix to the time-domain OFDM signal immediately before transmission. This process does not modify the information carried by the data symbols themselves, as the cyclic prefix is a redundant copy of a portion of the symbol. Its sole purpose is to facilitate reliable demodulation and mitigate the effects of inter-symbol interference.

In summary, the cyclic prefix insertion module 113 in an OFDM system inserts a cyclic prefix to the time-domain OFDM signal. This insertion creates a guard interval between symbols, preventing inter-symbol interference caused by multipath propagation or channel distortions. The cyclic prefix acts as a buffer, allowing the receiver to accurately demodulate each symbol and ensuring reliable data reception.

The digital-to-analog converter module 114 converts the time-domain OFDM signals to analog signals.

The digital-to-analog converter (DAC) module 114 in an OFDM (Orthogonal Frequency Division Multiplexing) system is responsible for converting the time-domain OFDM signals, which are in digital format, into analog signals. This conversion is a crucial step in preparing the signals for transmission over analog communication channels.

The DAC module 114 takes the time-domain OFDM signals, which consist of discrete digital samples representing the amplitudes of the signal at different time instants, and transforms them into continuous analog waveforms. This conversion allows the signals to be accurately represented as varying voltage levels in the analog domain.

The DAC module 114 operates by employing digital-to-analog conversion techniques. It utilizes high-resolution digital-to-analog converters that can accurately reconstruct the analog signal from the discrete digital samples. The module takes the digital values of the samples and generates corresponding analog voltage levels that accurately represent the time-domain OFDM signals.

The digital-to-analog conversion performed by the DAC module 114 is crucial for ensuring compatibility with analog communication channels. Many traditional communication systems, such as radio or audio systems, rely on analog signals for transmission. By converting the time-domain OFDM signals to analog, the DAC module enables seamless integration with these analog communication channels.

The accuracy and fidelity of the digital-to-analog conversion are essential to preserve the integrity of the transmitted signals. The DAC module 114 must have a sufficiently high resolution to faithfully reproduce the time-domain OFDM signals as continuous analog waveforms. This ensures that the transmitted analog signals closely match the original digital representation and minimize any potential distortions or loss of information.

In summary, the digital-to-analog converter module 114 in an OFDM system converts the time-domain OFDM signals, represented in digital format, into continuous analog signals. This conversion allows for compatibility with analog communication channels and ensures accurate representation of the signals in the analog domain. The DAC module plays a critical role in preparing the signals for transmission, enabling seamless integration with traditional analog communication systems.

In some embodiments, the lighting apparatus may also include a power amplification module 115.

The power amplification module 115 amplifies the RF signals to a suitable power level for transmission.

The power amplification module 115 in an OFDM (Orthogonal Frequency Division Multiplexing) system serves a crucial role in preparing the RF (Radio Frequency) signals for transmission by amplifying them to a suitable power level. This module ensures that the signals are boosted to a level that allows for effective transmission and reception.

After the RF signals are generated, typically through a combination of modulation, pilot insertion, mapping, and other signal processing stages, they might have relatively low power levels. The power amplification module 115 addresses this by taking these signals and amplifying their power to a level appropriate for transmission.

The power amplification process involves utilizing power amplifiers that can efficiently boost the power of the RF signals without introducing significant distortion or degradation. These amplifiers are designed to handle the specific frequency range and power requirements of the OFDM system.

Amplifying the RF signals to an adequate power level is essential for achieving reliable and long-range communication. It ensures that the signals can overcome various obstacles, such as attenuation, path loss, and interference, as they propagate through the wireless medium.

The power amplification module 115 must balance the need for amplification with considerations for linearity and efficiency. Linearity is crucial to avoid signal distortions that can degrade the quality of the transmitted data. Efficiency is also an important aspect to optimize power usage and minimize energy consumption.

Additionally, the power amplification module 115 may incorporate techniques such as adaptive power control to adjust the power level based on system requirements and channel conditions. This dynamic power control helps optimize the transmission performance, maintain signal quality, and manage power consumption.

In summary, the power amplification module 115 in an OFDM system is responsible for amplifying the RF signals to a suitable power level for transmission. By boosting the signals, the power amplification module ensures reliable and effective communication, overcoming signal attenuation and interference. The module employs power amplifiers designed for the specific frequency range and power requirements of the system while considering factors such as linearity, efficiency, and adaptive power control.

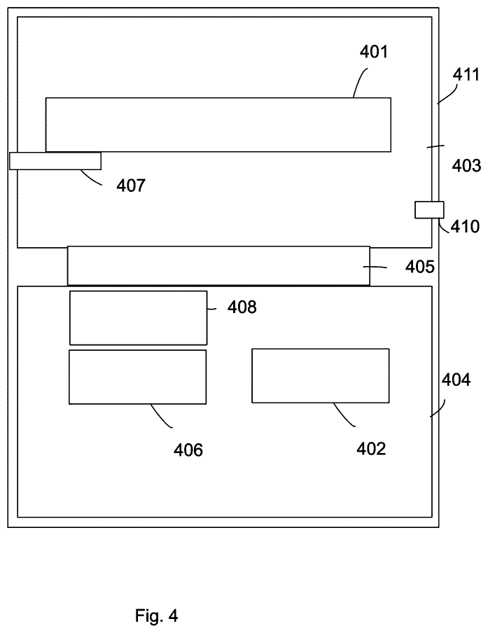

In FIG. 4, the OFDM modulation module 402 and the RF upconversion module 406 are placed in a second compartment 404. The second compartment may be made of plastic material so that wireless signal is not shielded by a metal surface.

The light source 401 is placed in a first compartment 403.

There is a heat insulation layer 405 between the first compartment 403 and the second compartment 404. For example, a foam, a plastic material or a bracket to keep a gap between the first compartment 403 and the second compartment 404.

In FIG. 1, the antenna module 117 has multiple antenna areas 118, 119, 120 for transmitting different RF signals 121, 122, 123 to the OFDM network 124 at the same time.

In FIG. 4, a metal heat dissipation unit 407 is used for dissipating heat of the light source 401.

The antenna areas 408 uses the metal heat dissipation unit 407 as a ground, e.g. connecting to the metal heat dissipation unit 407 via a wire, which may help transmit signals while not carrying too much heat to affect the wireless components.

In some embodiments, the lighting apparatus may also include a manual switch 410.

The manual switch 410 is disposed on a light housing 411 for holding the light source 401.

A user operates the manual switch 410 to enable or disable the OFDM modulation module.

There are several types of light devices that utilize LED (Light-Emitting Diode) technology as their light source, including downlights, panel lights, and spotlights. These LED-based light devices offer numerous advantages such as energy efficiency, long lifespan, and versatility in lighting applications. Furthermore, integrating OFDM components can enhance their capabilities in terms of color temperature adjustment and connectivity to other IoT (Internet of Things) devices.

Downlights, which are recessed light fixtures installed in ceilings, are commonly used for general lighting in homes, offices, and retail spaces. With LED technology, downlights provide efficient illumination while consuming less energy. Integrating OFDM components in LED downlights allows for precise control over color temperature, enabling users to adjust the light output to their desired warmth or coolness. This flexibility creates a comfortable and customizable lighting environment.

Panel lights are flat, slim light fixtures used for illuminating large areas such as offices, conference rooms, and schools. LED-based panel lights offer energy efficiency and uniform light distribution. By integrating OFDM components, panel lights can be equipped with wireless connectivity, allowing them to connect to IoT devices and smart lighting systems. This connectivity enables seamless integration with lighting control applications, scheduling, and integration with other IoT devices for automated lighting scenarios.

Spotlights are directional light fixtures used for accent lighting or highlighting specific objects or areas. LED spotlights provide focused illumination and are commonly used in art galleries, retail displays, and architectural lighting. By integrating OFDM components, LED spotlights can incorporate color temperature adjustment features, allowing users to change the color appearance of the light output to match specific moods, themes, or environments. This adaptability enhances their versatility and creative possibilities in various applications.

In addition to color temperature adjustment, integrating OFDM components in LED light devices opens up opportunities for connectivity with other IoT devices. By incorporating wireless communication capabilities, LED downlights, panel lights, and spotlights can seamlessly connect to IoT ecosystems and smart home or building automation systems. This connectivity enables users to control the lights remotely, create lighting schedules, and integrate them with other smart devices for comprehensive lighting management.

In summary, LED-based light devices such as downlights, panel lights, and spotlights offer energy-efficient and versatile lighting solutions. Integrating OFDM components enhances their functionality by enabling precise color temperature adjustment and connectivity to other IoT devices. This integration allows for customizable lighting environments, seamless integration with smart lighting systems, and convenient control options for enhanced comfort, energy management, and automation in various lighting applications.

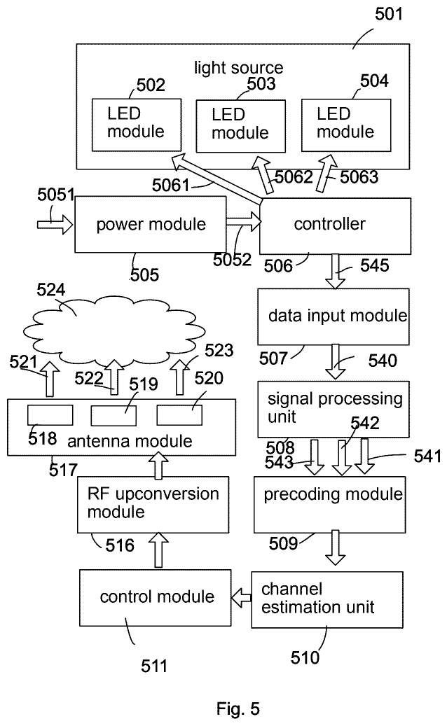

Please refer to FIG. 5. FIG. 5 illustrates another lighting apparatus embodiment.

In FIG. 5, a lighting apparatus includes a light source 501, a power module 505, a controller 506, a data input module 507 and a signal processing unit 508.

The light source includes multiple types of LED modules 502, 503, 504.

The power module 505 converts an AC power 5051 to a DC power 5052.

The controller 506 generates multiple driving currents 5061, 5062, 5063 supplied to the LED modules 502, 503, 504.

The data input module 507 is coupled to the controller 506.

The data input module 507 receives input data 545 to be transmitted. The data input module 507 may process the input data 545 or route the input data 545 directly as the input data 540 to be handled by the signal processing unit 508.

The signal processing unit 508 is coupled to the data input module 507 to process the input data 540 into multiple data streams 541, 542, 543 corresponding to the plurality of transmit antennas 518, 519, 520.

Each transmit antenna 518, 519, 520 transmits the corresponding data stream 541, 542, 543 independently.

As mentioned above, in FIG. 2, the input data may be generated by the controller 201 according to transmitted data of an electronic device 202 connected to the controller 201.

In some embodiments, the electronic device 202 is coupled to the controller 201 via a second network 203 with a different protocol from a first network 204 used by the plurality of transmit antennas.

In some embodiments, there are multiple electronic devices 202, 207, 208 wirelessly connected to the signal processing unit to share the plurality of antennas to transmit data of the multiple electronic devices 202, 207, 208.

In some embodiments, the electronic device is coupled with a same housing used for disposing the light source.

The control device adjusts the light source for the electronic device to operate normally.

In some embodiments, the electronic device is a camera device.

Recorded video of the camera device is encoded by the signal processing unit and sent to an external device over the Internet via the plurality of antennas.

In some embodiments, the electronic device communicates with an external device over Internet via the plurality of multiple antennas.

In some embodiments, the signal processing unit and the plurality of antennas shared with the electronic device.

The electronic device disables another signal processing unit of the external device for routing output data of the electronic device to the signal processing unit of the lighting apparatus via the second network.

In some embodiments, the electronic device also has a light source for providing illumination together with the lighting apparatus.

In some embodiments, the second network is an optical modulation network.

Data transmission between the lighting apparatus and the electronic device is modulated over an emitted light of the electronic device.

In some embodiments, the electronic device is a sensor for collecting ambient information aside the lighting apparatus.

The lighting apparatus is fixed to a stationary platform.

In some embodiments, the electronic device sends a connection parameter to the controller via the second network for the controller establishes the first network for operating the plurality of antennas.

In FIG. 5, the lighting apparatus may also include a precoding module 509.

The precoding module 509 applies precoding to the multiple data streams to enhance signal transmission performance.

Precoding is a signal processing technique that aims to enhance the transmission quality and overall system capacity in MIMO systems. By employing precoding, the precoding module modifies the transmitted signals in such a way that they can be optimally received and decoded by the intended receiver.

The purpose of applying precoding to the multiple data streams is to mitigate interference and improve signal quality. Since the multiple data streams are transmitted simultaneously using different antennas, there is a potential for interference between the streams. The precoding module addresses this challenge by manipulating the transmitted signals in a manner that minimizes interference and maximizes the received signal quality at the intended receiver.

By applying precoding, the precoding module optimizes the transmission parameters and adjusts the spatial characteristics of the transmitted signals. This enables better signal reception and decoding at the receiver, resulting in improved signal-to-noise ratio (SNR), increased data rates, and enhanced overall system performance.

The precoding module considers factors such as the channel state information (CSI) obtained from the channel estimation unit and the desired transmission objectives. Based on this information, it applies precoding algorithms that take into account the specific characteristics of the channel and the desired signal properties.

Overall, the role of the precoding module in MIMO transmission is to intelligently manipulate the transmitted signals to improve signal transmission performance. By employing precoding techniques, it optimizes the spatial characteristics of the transmitted signals, mitigates interference, and enhances the overall quality and efficiency of the wireless communication system.

Suppose there are several independent data streams that need to be transmitted simultaneously. Each data stream is associated with a specific transmit antenna. The precoding module receives these data streams and applies precoding techniques to modify the signals before transmission.

The main objective of precoding is to enhance the quality of the transmitted signals and improve overall system performance. By intelligently manipulating the transmitted signals, the precoding module aims to maximize the received signal quality at the intended receiver while minimizing interference and maintaining data integrity.

To achieve this, the precoding module takes into account various factors, including the characteristics of the wireless channel and the desired transmission objectives. It leverages information about the channel conditions, such as signal propagation, fading effects, and interference levels, to make informed decisions.

Based on the channel information, the precoding module applies specific precoding algorithms to optimize the transmitted signals. For instance, it may employ techniques like zero-forcing, minimum mean square error (MMSE), or maximum ratio transmission (MRT) depending on the channel conditions and system requirements.

Zero-forcing precoding aims to nullify or minimize interference between the data streams by applying appropriate signal processing techniques. MMSE precoding further enhances signal quality by considering the noise level and minimizing the mean square error between the transmitted and received signals. MRT takes advantage of favorable channel conditions to maximize signal reception and improve overall system capacity.

By employing the suitable precoding technique, the precoding module ensures that the transmitted signals are optimized for reception at the intended receiver. This leads to improved signal quality, increased data rates, and enhanced overall system performance.

In FIG. 5, the lighting apparatus may also include a channel estimation unit 510.

The channel estimation unit 510 estimates channel characteristics for each transmit antenna based on a receiver feedback information received from a receiver.

The channel estimation unit, denoted as unit 510, plays a crucial role in optimizing signal transmission in a wireless communication system. It focuses on estimating the characteristics of the channel between the transmitter and the receiver. By leveraging feedback information received from the receiver, the channel estimation unit gathers data that helps it understand the wireless channel's behavior.

The channel estimation unit operates by analyzing the feedback information provided by the receiver. This information typically includes measurements or observations related to the received signals. By studying these measurements, the channel estimation unit can infer valuable insights about the wireless channel's characteristics, such as signal propagation, fading effects, and interference levels.

Based on the received feedback, the channel estimation unit aims to estimate the channel's properties for each transmit antenna. It analyzes the data to understand how the transmitted signals are affected by the wireless channel during propagation. By accurately estimating the channel characteristics, the unit gains valuable knowledge about the quality and behavior of the transmission path.

This estimation process is crucial because it enables the system to adapt and optimize its transmission parameters based on the channel conditions. By understanding the channel characteristics, the system can adjust parameters like power allocation, modulation schemes, and coding schemes to enhance signal quality and maximize overall system performance.

The channel estimation unit continuously updates its estimations as new feedback information is received from the receiver. This ensures that the system adapts to dynamic changes in the wireless channel, such as variations in interference levels or fading conditions.

By estimating the channel characteristics for each transmit antenna, the channel estimation unit provides valuable information that is utilized by other modules or components of the system. This information helps in making informed decisions about signal processing, precoding, and other transmission strategies to optimize signal reception at the receiver.

The channel estimation unit in a wireless communication system analyzes feedback information received from the receiver to estimate the characteristics of the wireless channel for each transmit antenna. This estimation process enables the system to adapt and optimize its transmission parameters based on the channel conditions, ultimately improving signal quality and system performance.

In FIG. 5, the lighting apparatus may also include a control module 511.

The control module 511 adjusts the precoding based on the estimated channel characteristics.

The control module 511 is used for optimizing signal transmission in a wireless communication system that utilizes multiple transmit antennas and multiple receive antennas. It is responsible for adjusting the precoding scheme based on the estimated channel characteristics. By leveraging the information obtained from the estimation of channel properties, the control module ensures that the precoding parameters are optimized to suit the prevailing conditions of the wireless transmission environment.

Upon receiving the estimated channel characteristics from the channel estimation unit, the control module carefully analyzes this information to gain insights into the behavior of the wireless transmission channel. It considers factors such as signal propagation, variations in signal strength, and potential sources of interference to understand the quality and behavior of the transmission path.

Based on this analysis, the control module dynamically modifies the precoding scheme. Its primary objective is to enhance the performance of the system by adapting the precoding parameters in response to the estimated channel characteristics. By tailoring the precoding process to align with the estimated channel conditions, the control module optimizes the signal transmission to achieve improved signal quality and overall system efficiency.

The adjustment of precoding involves fine-tuning various parameters associated with the precoding scheme. These parameters may include transmission weights, power allocation, or the selection of appropriate spatial multiplexing techniques. The control module optimizes these parameters in real-time, taking into account the dynamic nature of the wireless transmission environment.

For example, if the estimated channel characteristics suggest the presence of significant interference, the control module may adjust the precoding scheme to mitigate the effects of interference on the transmitted signals. Conversely, if the channel conditions indicate favorable signal propagation and low levels of interference, the control module may optimize the precoding to maximize data rates and overall system capacity.

Through continuous monitoring and adaptation, the control module ensures that the precoding scheme remains synchronized with the estimated channel characteristics. By dynamically adjusting the precoding parameters, the control module maintains optimal signal transmission performance in the system, enabling efficient utilization of the wireless transmission resources and improved overall system reliability.

In some embodiments, at least a portion of the multiple transmit antennas are disposed on different planes.

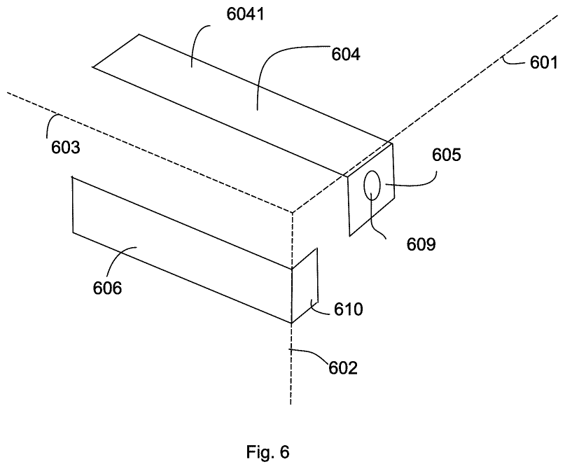

In FIG. 6, two transmit antennas 604, 606 are disposed on different planes. Dashed lines refer to three axis 601, 602, 603. In some embodiments, the two transmit antennas 604, 606 may be attached to exterior surface of interior surface of a housing for holding the light source and other components mentioned above.

In some embodiments, at least of the plurality of the transmit antennas is a three-dimension antenna.

In FIG. 6, the antenna 604 has a first part 6041 and a second part 605. There is a folding angle between the first part 6041 and the second part 605 making the antenna 604 a three-dimension antenna.

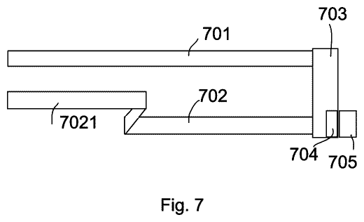

In FIG. 7, the three-dimension antenna includes a metal node 703, a first branch 701 and a second branch 702.

The first branch 701 and the second branch 702 are connected to the metal node 703.

The metal node 703 includes a feeding port 704 for receiving signal to be emitted. The wireless data are transmitted to the feeding node 705 to pass to the feeding port 704 to emit the signal from the antenna.

At least a portion of the first branch and at least a portion of the second branch are arranged on different planes.

For example, FIG. 7 shows the antenna 702 having a portion 7021 of the second branch 702 are arranged on different planes.

In some embodiments, three dimension antenna is a multi-band antenna for transmitting signals in multiple frequency ranges. For example, such band may receive and/or transmit signals of multiple frequency ranges.

In some embodiments, the first branch includes a first plurality of segments.

Each segment of the first plurality of segments is smaller than 1/10 of a lowest operating free-space wavelength of the multi-band antenna.

In some embodiments, the first plurality of segments includes at least ten segments.

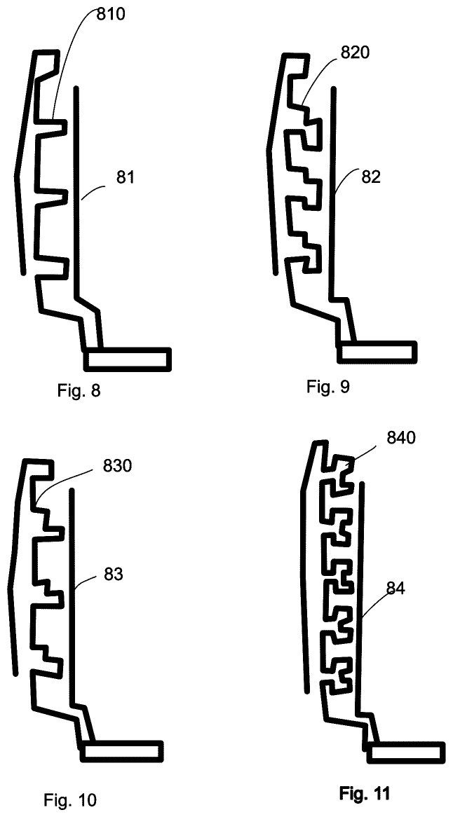

FIG. 8, FIG. 9, FIG. 10 and FIG. 11 illustrate four antennas with different segments.

The antennas 81, 82, 83, 84 in FIG. 8, FIG. 9, FIG. 10 and FIG. 11 all have two branches, but have different number of segments. A segment of the antenna mentioned here refers to a portion with bending curve so as to form recursive module that can receive multiple bands of frequency ranges. For example, FIG. 8 show an antenna 81 with four segments 810.

FIG. 9 shows an antenna 82 with four main segments 830 and each segments further has segments.

FIG. 10 shows another antenna 83 with multiple segments 830 arranged in a recursive order.

FIG. 11 shows another antenna 84 with multiple segments 840 with more segments than FIG. 10.

These antennas may be disposed on the light housing that hold the light source and other components. Non-metal shield may be used to protect the antenna while keeping signal not being interfered.

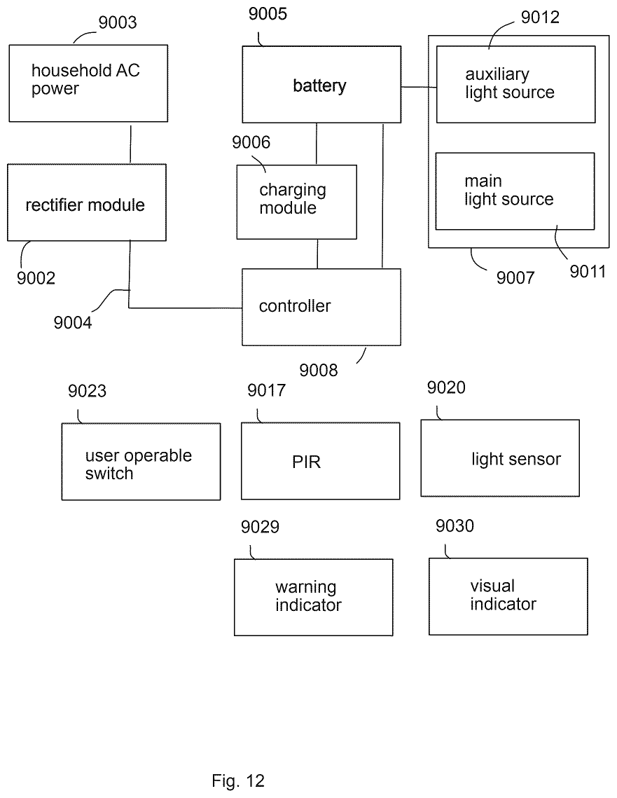

As illustrated in FIG. 12, the lighting apparatus includes a rectifier module 9002 configured to receive electrical energy from a household AC power source 9003. The household AC power source 9003 represents a fixed alternating-current power supply commonly available in residential environments for powering installed lighting devices. The rectifier module 9002 converts electrical energy from the household AC power source 9003 into DC power 9004 suitable for use by electronic circuits within the lighting apparatus.

The DC power 9004 generated by the rectifier module 9002 is distributed to multiple internal components to support normal lighting operation and energy management. In particular, the DC power 9004 is supplied to a charging module 9006 and a controller 9008. Conversion from alternating current to DC power 9004 enables stable operation of control logic, sensing elements, and light-emitting components.

The lighting apparatus further includes a battery 9005 configured to store electrical energy for use during periods when the household AC power source 9003 becomes unavailable. The battery 9005 provides an internal energy reserve allowing continued illumination operation during power interruption events. Battery capacity and chemistry may be selected to balance operating duration, safety considerations, and installation constraints.

The charging module 9006 is electrically coupled between the rectifier module 9002 and the battery 9005. The charging module 9006 manages transfer of DC power 9004 to the battery 9005 during periods when the household AC power source 9003 is available. Charging control functions may include current regulation, voltage regulation, charge termination, and battery protection to maintain battery health and readiness.

A light source 9007 is provided to generate illumination for the lighting apparatus. The light source 9007 may include multiple light-emitting elements arranged to provide both primary and auxiliary illumination functions. Electrical power supplied to the light source 9007 originates from the household AC power source 9003 during normal operation and from the battery 9005 during emergency operation.

In the illustrated embodiment, the light source 9007 includes a main light source 9011 and an auxiliary light source 9012. The main light source 9011 is configured to provide higher-brightness illumination for normal usage scenarios when the household AC power source 9003 is available. The auxiliary light source 9012 is configured to provide lower-power illumination suitable for battery-powered operation during power interruption conditions.

Operation of the lighting apparatus is coordinated by a controller 9008. The controller 9008 monitors availability of the household AC power source 9003 and controls distribution of electrical energy to the main light source 9011 and the auxiliary light source 9012. Based on detected power conditions, the controller 9008 selectively enables lighting functions while preventing unnecessary discharge of the battery 9005.

As further illustrated in FIG. 12, the lighting apparatus may include a passive infrared motion sensor 9017 and a light sensor 9020 electrically coupled to the controller 9008. The passive infrared motion sensor 9017 detects human presence based on changes in infrared radiation, while the light sensor 9020 detects ambient light conditions. Sensor inputs allow the controller 9008 to determine appropriate illumination behavior during battery-powered operation.

A user-operable mode switch 9023 is provided to allow manual selection of operating behaviors. The user-operable mode switch 9023 enables user control over battery-powered illumination characteristics such as output level or operating duration. Manual input through the user-operable mode switch 9023 supplements automatic control logic executed by the controller 9008.

The lighting apparatus further includes a warning indicator 9029 configured to provide notification regarding battery condition. In some embodiments, the warning indicator 9029 includes a visual indicator 9030 visible to a user during normal observation of the lighting apparatus. The controller 9008 activates the warning indicator 9029 when battery charge level falls below a predetermined threshold, thereby alerting the user to reduced available energy.

In addition to normal operating modes, the controller 9008 may operate the lighting apparatus in a third operating mode 9031 dedicated to battery conditioning. During the third operating mode 9031, controlled discharge and recharge cycles are performed to maintain long-term battery health while preserving sufficient stored energy for emergency illumination. This operating mode enhances reliability and longevity of the battery 9005 over extended service life.

In some embodiments, a lighting apparatus includes a rectifier module configured to receive a household AC power source and convert the household AC power source into DC power for internal use. The lighting apparatus further includes a battery for storing electrical energy, as well as a charging module electrically coupled to the rectifier module and the battery, with the charging module configured to manage energy transfer from the rectifier module to the battery. The lighting apparatus also includes a light source for producing illumination and a controller electrically coupled to the rectifier module, the battery, the charging module, and the light source. The controller detects availability of the household AC power source and selectively operates the lighting apparatus in a first operating mode when the household AC power source is available and in a second operating mode when the household AC power source is unavailable. During the first operating mode, the controller prevents the battery from supplying power to the light source in order to avoid unnecessary battery discharge. During the second operating mode, the controller allows the battery to supply power to the light source to maintain illumination during absence of the household AC power source.

In some embodiments, the household AC power source refers to electrical power delivered through fixed building wiring for residential lighting applications. Such a household AC power source commonly supplies alternating current at voltage levels suitable for direct connection to lighting devices installed in homes, apartments, bathrooms, hallways, and similar indoor environments. The household AC power source may also include power supplied in multi-unit residential buildings as well as power distributed within mixed-use buildings where lighting fixtures remain permanently connected.

In some embodiments, the rectifier module performs conversion of alternating current into direct current suitable for powering electronic components within the lighting apparatus. The rectifier module may include diode-based rectification circuits, active rectification circuits using controlled semiconductor devices, filtering components for voltage smoothing, as well as protection components for handling voltage fluctuations. Different rectifier module designs may be selected based on efficiency requirements, thermal constraints, and cost considerations.

In some embodiments, the battery serves as an energy reserve intended primarily for use during periods when the household AC power source becomes unavailable. The battery may include rechargeable electrochemical storage devices such as lithium-based batteries, nickel-based batteries, or other rechargeable battery chemistries suitable for indoor lighting applications. Battery capacity may be selected to balance operating duration, physical size, safety requirements, and expected emergency usage time.

In some embodiments, the charging module manages safe energy transfer from the rectifier module to the battery. The charging module may regulate charging current, charging voltage, and charging duration to maintain battery health. The charging module may further include protective functions such as overcharge protection, temperature monitoring, and charge termination control. Charging behavior may be optimized to keep the battery in a ready state without excessive charging stress.

In some embodiments, the light source includes one or more illumination elements configured to emit visible light when electrical power becomes available. The light source may include light emitting diodes, organic light emitting diodes, filament-based light sources, or other solid-state lighting elements. The light source may be configured for continuous illumination, intermittent illumination, or adaptive illumination depending on operating mode and control logic.

In some embodiments, the controller serves as a central control unit coordinating operation of the rectifier module, the charging module, the battery, and the light source. The controller may include a microcontroller, a microprocessor, dedicated logic circuitry, or programmable control hardware. The controller executes control logic based on detected power conditions and internal state information to manage energy usage efficiently.

In some embodiments, detection of availability of the household AC power source occurs through voltage sensing, current sensing, signal isolation circuits, or other power detection mechanisms. The controller may continuously monitor the presence of the household AC power source to enable rapid transition between operating modes. Detection accuracy ensures correct selection of operating mode without false transitions.

In some embodiments, the first operating mode prioritizes direct operation from the household AC power source while preserving battery energy. During the first operating mode, prevention of battery discharge ensures stored energy remains fully available for later emergency use. This operating strategy improves reliability during unexpected power interruptions and reduces unnecessary battery wear.

In some embodiments, the second operating mode activates automatically upon loss of the household AC power source. During the second operating mode, the battery supplies power to the light source to provide continued illumination. This operating behavior allows the lighting apparatus to function as an emergency lighting device without requiring user intervention.

In some embodiments, selective operation between the first operating mode and the second operating mode provides functional behavior similar to an uninterruptible power supply while remaining integrated within a lighting apparatus. Energy management through mode-based control extends usable battery life, improves safety during power outages, and enhances overall user experience in residential lighting environments.

In some embodiments, the lighting apparatus includes a main light source and an auxiliary light source as separate illumination elements within the same lighting system. The main light source is intended for primary illumination tasks such as grooming, cleaning, reading, and general room lighting. The auxiliary light source is intended for supplemental illumination tasks such as nighttime guidance, low-brightness visibility, and emergency lighting during power interruptions.

In some embodiments, the main light source and the auxiliary light source are physically distinct light-emitting structures. The main light source may occupy a larger area within a lighting fixture, while the auxiliary light source may occupy a smaller area positioned to provide directional or localized illumination. Physical separation allows independent electrical control and enables different operating behaviors under different power conditions.

In some embodiments, the main light source consumes more electrical power than the auxiliary light source during operation. Higher power consumption may result from higher brightness output, larger numbers of light-emitting elements, wider illumination coverage, higher current drive levels, or combinations of these factors. Increased power consumption makes the main light source less suitable for extended operation using stored battery energy.

In some embodiments, the auxiliary light source consumes less electrical power than the main light source to support longer operating time when powered by the battery. Reduced power consumption may result from lower brightness, fewer light-emitting elements, reduced current drive, or simplified optical output. Lower power consumption enables the auxiliary light source to provide meaningful illumination while preserving battery capacity during extended power outages.

In some embodiments, the controller disables the main light source during the second operating mode when the household AC power source becomes unavailable. Disabling the main light source prevents rapid battery depletion caused by high power demand. This operating behavior ensures battery energy remains available for essential illumination rather than being consumed by high-brightness lighting.

In some embodiments, the controller enables the auxiliary light source during the second operating mode to provide illumination using battery power. The auxiliary light source provides sufficient visibility for safe movement, orientation, and basic tasks during periods without household AC power. The auxiliary light source operates as an emergency illumination element optimized for energy efficiency.

In some embodiments, the controller enables the main light source during the first operating mode when the household AC power source remains available. Activation of the main light source during the first operating mode allows full-brightness illumination without concern for battery depletion. Battery energy remains preserved during normal operation when external power remains present.

In some embodiments, separation of operating behavior between the main light source and the auxiliary light source creates functional isolation between normal lighting operation and emergency lighting operation. Functional isolation prevents overlap of high-power illumination and battery-powered operation. This separation improves predictability, reliability, and energy efficiency of the lighting apparatus.

In some embodiments, the main light source includes adjustable color temperature capability, adjustable brightness capability, or both, supporting user comfort and task-specific lighting needs during normal operation. The auxiliary light source may use a fixed color temperature and fixed brightness optimized for visibility rather than ambiance. Distinct design goals for the main light source and the auxiliary light source enhance overall system versatility.

In some embodiments, inclusion of both the main light source and the auxiliary light source within a single lighting apparatus enables seamless transition between normal lighting conditions and emergency lighting conditions without requiring separate fixtures. The lighting apparatus provides continuous usability across varying power availability scenarios while preserving battery energy for periods when battery power becomes essential.

In some embodiments, the lighting apparatus uses the household AC power source to charge the battery during the first operating mode. Energy from the household AC power source flows through the rectifier module and into the charging module, with the charging module regulating energy transfer into the battery. This charging behavior ensures stored energy remains available for later use during power interruptions.

In some embodiments, charging of the battery during the first operating mode occurs concurrently with normal illumination operation. The lighting apparatus continues to operate the main light source using external power while the charging module replenishes battery capacity. Battery charging during normal operation avoids reliance on battery energy for lighting functions.

In some embodiments, electrical blocking of battery discharge occurs during the first operating mode. Electrical blocking may be achieved through switching elements, power management circuits, or control logic implemented by the controller. Blocking battery discharge prevents unintended battery drain caused by internal leakage paths, sensing circuits, or auxiliary loads.

In some embodiments, prevention of battery discharge during the first operating mode extends battery service life. Reduced cycling minimizes chemical degradation within the battery. Maintaining higher average battery charge level improves reliability during emergency use scenarios.

In some embodiments, the auxiliary light source operates at a lower brightness level than the main light source. Lower brightness output reduces electrical current demand and thermal generation. Reduced brightness supports longer operating duration when powered by the battery during the second operating mode.

In some embodiments, lower brightness of the auxiliary light source remains sufficient for human orientation and safety. Illumination provided by the auxiliary light source allows safe movement, obstacle avoidance, and basic visibility during nighttime or power outage conditions. The auxiliary light source prioritizes function over visual ambiance.

In some embodiments, the auxiliary light source includes light emitting elements selected for high luminous efficiency. High luminous efficiency converts a greater proportion of electrical energy into visible light. Improved efficiency further extends battery-powered illumination duration.

In some embodiments, the lighting apparatus includes a passive infrared motion sensor electrically coupled to the controller. The passive infrared motion sensor detects changes in infrared radiation associated with human movement. Detection capability enables responsive illumination behavior without continuous light operation.

In some embodiments, coupling between the passive infrared motion sensor and the controller allows selective activation of illumination functions. The controller receives motion detection signals and determines whether illumination activation conditions have been satisfied. Motion-based activation reduces unnecessary energy usage during periods without human presence.

In some embodiments, integration of the passive infrared motion sensor with battery-powered operation enhances overall system efficiency. Illumination occurs only when human activity exists in the illuminated area. Energy stored in the battery remains preserved during idle periods without detected motion, further extending emergency lighting availability.

In some embodiments, the lighting apparatus activates the auxiliary light source during the second operating mode only after detection of human presence by the passive infrared motion sensor. This operating behavior ensures illumination occurs in response to actual user activity rather than continuous lighting. Controlled activation reduces unnecessary battery consumption during extended periods without movement.

In some embodiments, detection of human presence occurs when the passive infrared motion sensor identifies changes in infrared radiation associated with movement of a human body. Such detection enables responsive illumination behavior suitable for nighttime use, emergency scenarios, and low-visibility environments. Motion-based activation improves user convenience while conserving stored energy.

In some embodiments, the controller initiates illumination of the auxiliary light source only after a valid motion signal has been received. The controller evaluates motion detection input before enabling electrical power delivery to the auxiliary light source. Evaluation of motion input avoids illumination triggered by electrical noise or transient environmental changes.

In some embodiments, the controller turns off the auxiliary light source after expiration of a preset delay following detection of human presence. The preset delay defines a duration during which illumination remains active after motion detection ceases. Automatic turn-off prevents prolonged illumination after human activity ends.

In some embodiments, the preset delay is configurable through internal programming, component selection, or user configuration interfaces. Different preset delay values support different usage environments such as hallways, bathrooms, stairways, or bedrooms. Adjustable delay timing balances user comfort and battery conservation.

In some embodiments, the lighting apparatus includes a light sensor electrically coupled to the controller. The light sensor detects ambient light conditions surrounding the lighting apparatus. Ambient light detection enables context-aware illumination behavior.

In some embodiments, the controller enables the auxiliary light source during the second operating mode only when ambient light detected by the light sensor falls below a preset threshold and human presence has been detected. Combined evaluation of ambient light level and motion detection prevents illumination during daylight conditions. This combined logic further reduces unnecessary battery discharge.

In some embodiments, the preset ambient light threshold is selected to represent low-light conditions appropriate for auxiliary illumination. Threshold selection may vary based on installation location, user preference, or regulatory guidelines. Proper threshold selection ensures illumination activates only when visual assistance becomes necessary.

In some embodiments, the lighting apparatus includes a user-operable mode switch electrically coupled to the controller. The user-operable mode switch allows manual selection of operating behaviors. Manual input capability provides flexibility beyond automatic control logic.

In some embodiments, the user-operable mode switch enables adjustment of lighting behavior during battery-powered operation. User selection allows customization of illumination response based on personal preference, expected outage duration, or environmental conditions. User control enhances adaptability of the lighting apparatus across different use scenarios.

In some embodiments, the user-operable mode switch allows selection between a first battery supply level and a second battery supply level during the second operating mode. Selection of different battery supply levels enables adjustment of illumination behavior during battery-powered operation. Mode selection supports adaptation to different emergency conditions.

In some embodiments, the first battery supply level provides a higher output current to the auxiliary light source. Higher output current results in increased brightness from the auxiliary light source. Increased brightness supports situations requiring stronger illumination such as navigation across larger spaces or performance of short-duration tasks.

In some embodiments, higher output current consumption corresponds to faster battery energy usage. Faster energy usage remains acceptable during brief power interruptions where strong illumination takes priority. Selection of the first battery supply level prioritizes visibility over extended operating duration.

In some embodiments, the second battery supply level provides a lower output current to the auxiliary light source. Lower output current results in reduced brightness from the auxiliary light source. Reduced brightness lowers energy consumption during battery-powered operation.

In some embodiments, reduced output current extends operating duration of the battery during the second operating mode. Extended operating duration improves reliability during prolonged power outages. Battery preservation becomes critical during emergency conditions with uncertain restoration time.

In some embodiments, the second battery supply level supports overnight illumination needs without excessive battery depletion. Reduced illumination remains sufficient for orientation, safety, and basic navigation. Extended operation enhances user confidence during extended outages.

In some embodiments, switching between the first battery supply level and the second battery supply level occurs through manual user input. Manual selection provides direct control over illumination behavior. User input allows immediate response to changing environmental conditions.

In some embodiments, switching between battery supply levels occurs without interrupting illumination output. Seamless transition avoids sudden changes in visibility. Smooth switching improves user experience during emergency lighting operation.

In some embodiments, implementation of multiple battery supply levels provides flexibility across a wide range of power outage scenarios. Short outages benefit from higher brightness selection. Long outages benefit from energy conservation selection.

In some embodiments, inclusion of selectable battery supply levels enhances overall energy management strategy within the lighting apparatus. Controlled energy delivery balances illumination quality and battery endurance. Adaptive battery supply behavior contributes to reliable emergency lighting performance.

In some embodiments, the controller monitors a battery charge level during operation of the lighting apparatus. Battery charge level monitoring provides information regarding remaining stored energy available for emergency illumination. Continuous awareness of battery condition supports reliable operation during power interruption events.

In some embodiments, the controller activates a warning indicator when the battery charge level falls below a preset threshold. Activation of the warning indicator alerts a user to reduced available energy. Early warning enables timely charging actions during periods when household AC power remains available.

In some embodiments, the warning indicator includes a visual indicator integrated into the lighting apparatus. Visual indicators may include light-emitting elements, display segments, or symbolic illumination patterns visible during normal observation of the lighting apparatus. Visual feedback allows immediate recognition of battery condition without additional equipment.

In some embodiments, the visual indicator communicates battery status through color changes, brightness variation, blinking patterns, or steady illumination states. Different visual presentations correspond to different battery charge levels. Clear visual signaling improves user awareness and reduces risk of unexpected battery depletion.

In some embodiments, the controller operates the lighting apparatus in a third operating mode dedicated to battery conditioning. Battery conditioning supports long-term battery health during extended installation lifetimes. Periodic conditioning maintains stable electrochemical behavior within the battery.

In some embodiments, the third operating mode initiates controlled partial discharge of the battery followed by controlled recharging. Partial discharge avoids continuous full-charge storage conditions. Controlled recharging restores energy capacity after discharge completion.

In some embodiments, partial discharge during the third operating mode limits battery discharge to no more than half of a rated battery capacity. Limiting discharge depth preserves sufficient remaining energy for emergency lighting availability. Shallow discharge avoids excessive stress on battery chemistry.

In some embodiments, controlled discharge depth balances battery maintenance with readiness for sudden power interruption. Preservation of emergency reserve energy ensures immediate illumination capability even during battery conditioning activity. Energy management remains aligned with safety requirements.

In some embodiments, subsequent recharging during the third operating mode restores the battery to an optimal charge level. Restoration prepares the battery for future emergency use. Recharging parameters may follow manufacturer-recommended charging profiles.

In some embodiments, inclusion of battery charge monitoring, warning indication, and controlled conditioning enhances long-term reliability of the lighting apparatus. Combined management features reduce risk of battery failure during critical moments. Integrated battery health management supports dependable emergency lighting performance across extended service periods.

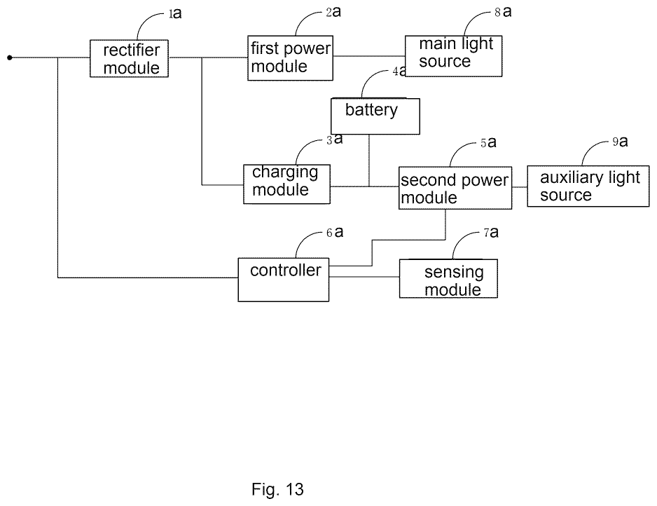

FIG. 13 is a schematic diagram illustrating a circuit structure of an LED lamp control circuit provided according to an embodiment of the present utility model. Referring to FIG. 13, the LED lamp control circuit includes a rectifier module 1a, a first power module 2a, a charging module 3a, a battery 4a, a second power module 5a, a controller module 6a, and a sensing module 7a.

An input terminal of the rectifier module 1a is connected to a household AC power source, and an output terminal of the rectifier module 1a is connected to an input terminal of the first power module 2a and an input terminal of the charging module 3a. An output terminal of the first power module 2a is configured to supply power to a main light source.

An output terminal of the charging module 3a is connected to an input terminal of the second power module 5a and the battery 4a. An output terminal of the second power module 5a is configured to supply power to an auxiliary light source.

A first input terminal of the controller module 6a is connected to the input terminal of the rectifier module 1a, a second input terminal of the controller module 6a is connected to the sensing module 7a, and an output terminal of the controller module 6a is connected to a control terminal of the second power module 5a.

Referring to FIG. 13, when the household AC power source supplies power, namely when a switch is turned on, the household AC power source supplies power to the main light source through the first power module 2a, thereby satisfying high-brightness illumination requirements for daily mirror-front lighting applications.

The controller module 6a detects AC power supply status. When disconnection of the household AC power source is detected, power is drawn from the battery 4a and supplied to the auxiliary light source through the second power module 5a, thereby adapting to low-brightness nighttime scenarios. In addition, the sensing module 7a is provided, and the controller module 6a receives signals from the sensing module 7a through the second input terminal to obtain information such as human presence and ambient light brightness. Based on sensed information, intelligent functions such as illumination upon arrival and extinguishing upon departure and ambient-light-adaptive dimming of the auxiliary light source are implemented.

The present application detects AC power supply status and automatically switches between the main light source and the auxiliary light source, thereby realizing automatic and accurate emergency lighting switching without manual intervention. On the basis of satisfying basic mirror-front lighting requirements, auxiliary lighting functionality is added, enabling users to obtain necessary illumination during nighttime or dim environments when AC power is interrupted, enriching lighting functions, expanding application scenarios, and satisfying multiple user needs.

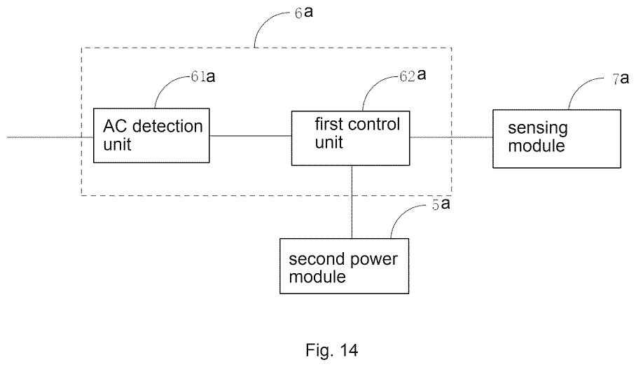

In one possible embodiment, referring to FIG. 14, the controller module 6a includes an AC detection unit 61a and a first control unit 62a. An input terminal of the AC detection unit 61a is connected to the first input terminal of the controller module 6a, and an output terminal of the AC detection unit 61a is connected to a first input terminal of the first control unit 62a to detect AC power supply. A second input terminal of the first control unit 62a is connected to the sensing module 7a, and an output terminal of the first control unit 62a is connected to the control terminal of the second power module 5a.

The AC detection unit 61a serves as an independent functional unit capable of directly acquiring signals from the household AC power source to determine whether the household AC power source supplies power normally. When normal power supply is detected, the second power module 5a is controlled to remain inactive so that the auxiliary light source remains off, while the first power module 2a operates normally to illuminate the main light source. When the household AC power source is disconnected, the first power module 2a becomes inactive so that the main light source remains off, while the battery 4a supplies power to the second power module 5a, and the first control unit 62a controls the second power module 5a to supply power to the auxiliary light source. For example, the first control unit 62a transmits a PWM signal to the second power module 5a to control brightness of the auxiliary light source. When normal AC power supply is detected, the first control unit 62a maintains a low-level or high-impedance output to the second power module 5a, disabling the auxiliary light source regardless of triggering of the sensing module 7a, thereby effectively eliminating standby power consumption under AC operation and achieving high energy efficiency.

Enablement of the main light source and the auxiliary light source is determined based on household AC power supply status. Such hard isolation, whereby the auxiliary light source is forcibly disabled when household AC power is present and the main light source is forcibly disabled when household AC power is absent, avoids functional interference and unnecessary power consumption at a system architecture level.

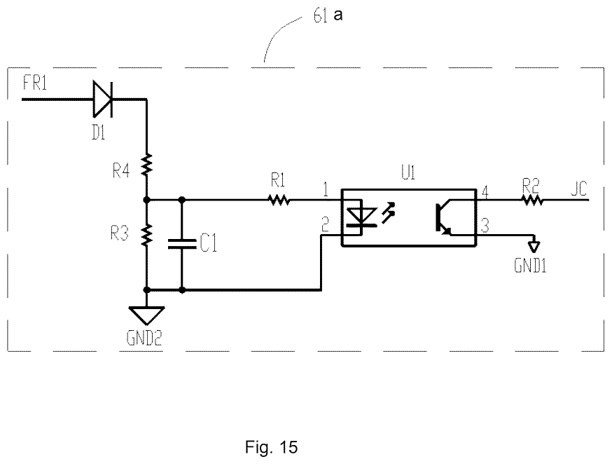

In one possible embodiment, referring to FIG. 15, the AC detection unit 61a includes an optocoupler U1a, a first diode D1a, a first resistor R1a, a second resistor R2a, a third resistor R3a, a fourth resistor R4a, and a first capacitor C1a. A positive input terminal of the optocoupler U1a is connected to a first terminal of the first resistor R1a, and a negative input terminal of the optocoupler U1a is connected to a second ground terminal GND2a. A positive output terminal of the optocoupler U1a is connected to a first terminal of the second resistor R2a, and a negative output terminal of the optocoupler U1a is connected to a first ground terminal GND1a. A second terminal of the first resistor R1a is connected to a first terminal of the first capacitor C1a, a first terminal of the third resistor R3a, and a first terminal of the fourth resistor R4a. A second terminal of the first capacitor C1a and a second terminal of the third resistor R3a are connected to the second ground terminal GND2a. An anode of the first diode D1a is connected to an input terminal of the AC detection unit 61a, and a cathode of the first diode D1a is connected to a second terminal of the fourth resistor R4a. A second terminal of the second resistor R2a is connected to an output terminal of the AC detection unit 61a.

Referring to FIG. 15, the input terminal of the AC detection unit 61a is connected to the household AC power source. When AC power is normal, current during a positive half cycle flows through the first diode D1a toward the fourth resistor R4a, causing the first diode D1a and the optocoupler U1a to conduct, and the output terminal of the AC detection unit 61a outputs a low-level signal to the first control unit 62a indicating normal AC power supply. When AC power is interrupted, the optocoupler U1a becomes non-conductive, and the output terminal of the AC detection unit 61a outputs a high-level signal to the first control unit 62a indicating AC power disconnection.

Optical isolation provided by the optocoupler U1a completely isolates high-voltage components, surges, and noise from the AC power side, preventing strong electrical interference from entering low-voltage circuitry of the first control unit 62a and protecting control circuitry from damage or malfunction. The circuit structure is simple, response speed is fast, cost is low, and operational stability is high.

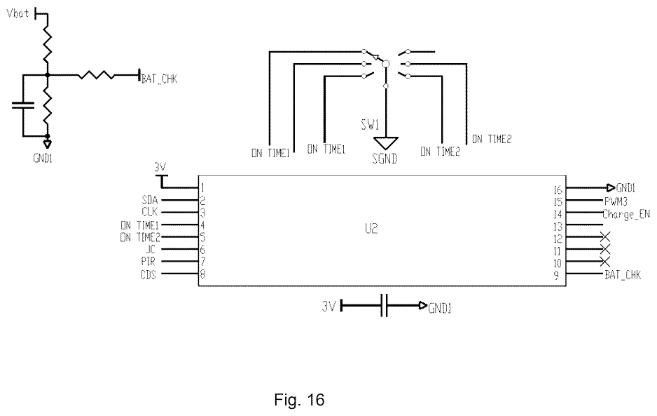

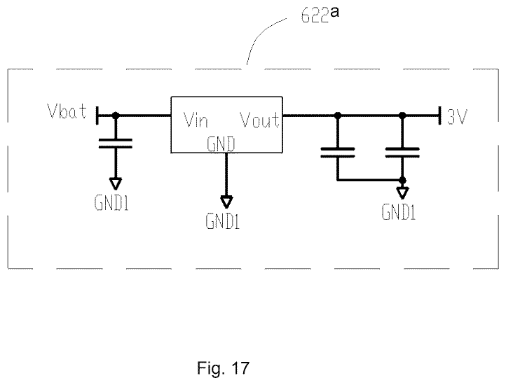

In one possible embodiment, referring to FIG. 16 and FIG. 17, the first control unit 62a includes a first control chip U2a, a first power supply unit 622a, and a mode DIP switch SW1a. An input terminal of the first power supply unit 622a is connected to an output terminal of the charging module 3a, and an output terminal of the first power supply unit 622a is connected to a power supply terminal of the first control chip U2a. The first control chip U2a is connected to the output terminal of the AC detection unit 61a, the sensing module 7a, and the mode DIP switch SW1a. The first control chip U2a is also connected to the control terminal of the second power module 5a to transmit dimming signals for the auxiliary light source.

The first control unit 62a draws power from the battery 4a through the first power supply unit 622a. The mode DIP switch SW1a is provided to adjust operating modes of the auxiliary light source. As an example, the first power supply unit 622a may be implemented as a low-dropout linear regulator, with circuit details illustrated in FIG. 17 and not further described herein.

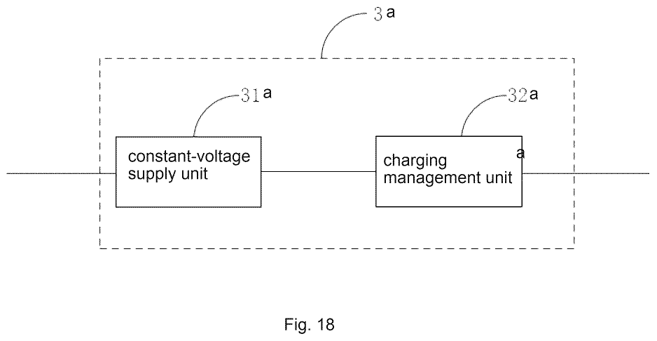

In one possible embodiment, referring to FIG. 18, the charging module 3a includes a constant-voltage supply unit 31a and a charging management unit 32a. An input terminal of the constant-voltage supply unit 31a is connected to an input terminal of the charging module 3a, and an output terminal of the constant-voltage supply unit 31a is connected to an input terminal of the charging management unit 32a. An output terminal of the charging management unit 32a is connected to an output terminal of the charging module 3a. The constant-voltage supply unit 31a converts fluctuating DC output from the rectifier module 1a into stable DC voltage to provide a smooth input for charging the battery 4a. The charging management unit 32a implements intelligent charging strategies to prevent overcharging, overcurrent, and overheating of the battery 4a, thereby extending battery service life and improving charging safety.

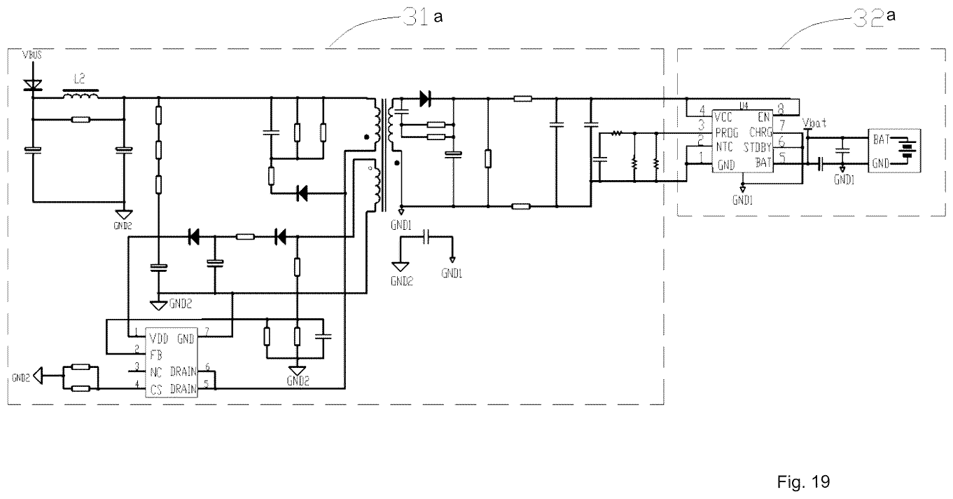

As an example, circuit principles of the constant-voltage supply unit 31a and the charging management unit 32a are illustrated in FIG. 19 and are not further described herein.

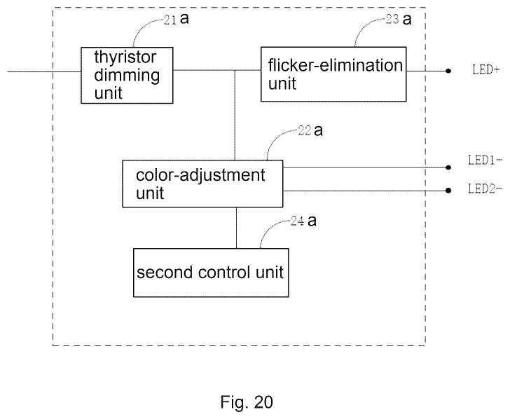

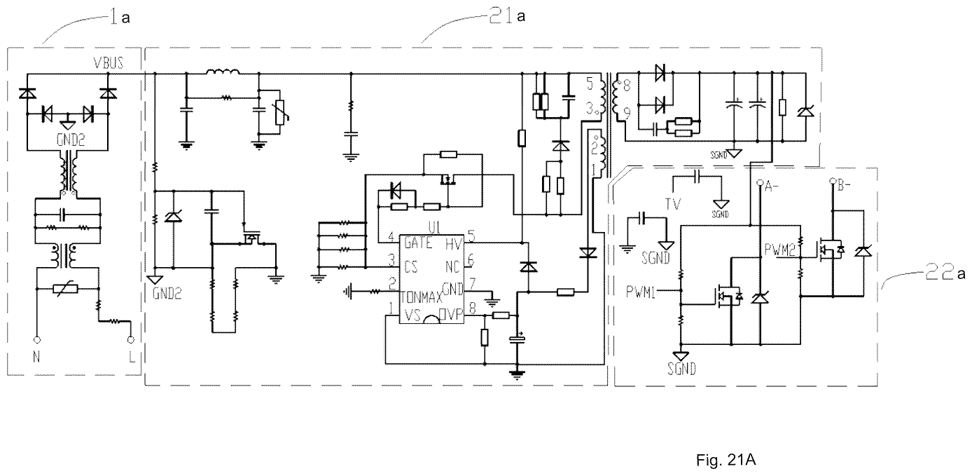

In one possible embodiment, referring to FIG. 20, the main light source includes at least two LED strings, and the first power module 2a includes a thyristor dimming unit 21a, a color-adjustment unit 22a, a flicker-elimination unit 23a, and a second control unit 24a. An input terminal of the thyristor dimming unit 21a is connected to an input terminal of the first power module 2a, and an output terminal of the thyristor dimming unit 21a is connected to an input terminal of the flicker-elimination unit 23a and an input terminal of the color-adjustment unit 22a. Output terminals of the color-adjustment unit 22a are connected to negative electrodes of the LED strings, and an output terminal of the flicker-elimination unit 23a is connected to positive electrodes of the LED strings. The second control unit 24a is connected to a control terminal of the color-adjustment unit 22a.

The thyristor dimming unit 21a enables smooth brightness adjustment of the main light source to accommodate different illumination requirements. The second control unit 24a controls current distribution among multiple LED strings through the color-adjustment unit 22a to achieve color temperature switching and improve lighting comfort. The flicker-elimination unit 23a filters current ripple to provide stable current to the LED strings, thereby avoiding flicker and reducing eye strain during prolonged illumination.

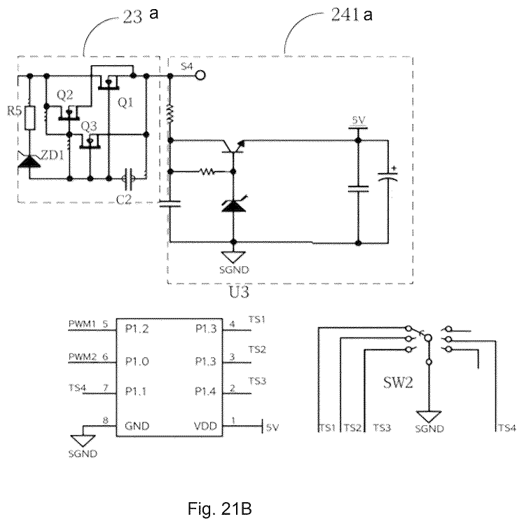

In one possible embodiment, referring to FIG. 21B, the flicker-elimination unit 23a includes a first switching transistor Q1a, a second switching transistor Q2a, a third switching transistor Q3a, a fifth resistor R5a, a second capacitor C2a, and a Zener diode ZD1a. Ripple current output from the thyristor dimming unit 21a is smoothed by energy storage and release of the second capacitor C2a and parallel switching transistors. The Zener diode ZD1a stabilizes control voltage to ensure consistent conduction behavior, while parallel transistor architecture increases current capability, reduces thermal stress, and extends component lifespan.

In one possible embodiment, referring to FIG. 21B, the second control unit 24a includes a second control chip U3a, a color-selection DIP switch SW2a, and a second power supply unit 241a. An input terminal of the second power supply unit 241a is connected to an output terminal of the flicker-elimination unit 23a, and an output terminal of the second power supply unit 241a is connected to a power supply terminal of the second control chip U3a. The color-selection DIP switch SW2a is connected to the second control chip U3a, and the second control chip U3a is further connected to the control terminal of the color-adjustment unit 22a to transmit color adjustment signals.

The color-selection DIP switch SW2a allows preset configuration of multiple color temperature or color combinations, enabling user adjustment through manual switching. The second power supply unit 241a provides stable operating voltage to the second control chip U3a, avoiding interference caused by fluctuations in main light source current. The second control chip U3a outputs precise control instructions to the color-adjustment unit 22a to adjust current ratios among LED strings and achieve color temperature adjustment.

Further, the color-selection DIP switch SW2a and the mode DIP switch SW1a may be replaced by touch keys, infrared remote control, or wireless communication modules such as Bluetooth or Wi-Fi to enable mobile application control, depending on application requirements. Circuit principles of the thyristor dimming unit 21a and the color-adjustment unit 22a are illustrated in FIG. 21A and are not further described herein.

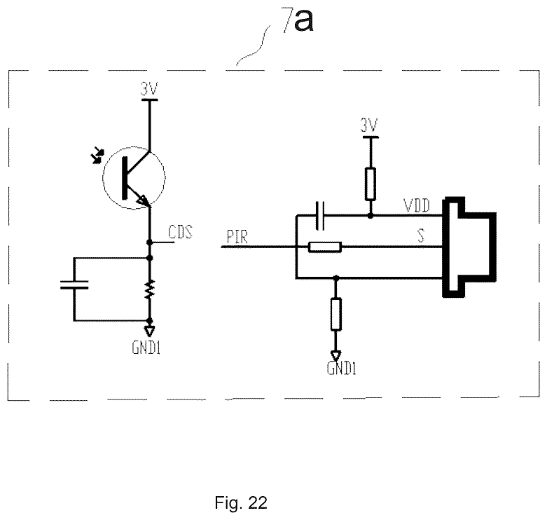

In one possible embodiment, referring to FIG. 22, the sensing module 7a includes a passive infrared motion sensor and a light sensor, both connected to the second control chip U3a. The passive infrared motion sensor detects human presence, and the light sensor detects ambient illumination level.

The passive infrared motion sensor provides human detection signals, and the light sensor compares detected ambient illumination with a preset threshold. Only when ambient illumination is lower than the preset threshold and human presence is detected is the auxiliary light source activated, thereby ensuring operation only under dark conditions with human presence and maximizing battery-powered operating duration. The auxiliary light source is automatically turned off after a user-defined preset delay time, improving adaptability and personalized user experience.

The present application applies combined filtering of ambient light sensing and human motion sensing to ensure precise activation behavior. In combination with mode isolation between the main light source and the auxiliary light source, standby power consumption under AC operation and false triggering power consumption under battery operation are eliminated.

Further, the passive infrared motion sensor may be replaced with a microwave radar sensor to detect subtle or stationary human presence, thereby improving detection sensitivity depending on application requirements.

Corresponding to the above embodiments, the present utility model further provides an intelligent mirror-front lamp including an auxiliary light source, a main light source, and the LED lamp control circuit provided in any of the above embodiments. The LED lamp control circuit supplies power to the auxiliary light source and the main light source.

In some embodiments, the lighting apparatus disclosed herein may be implemented in various fixed lighting installations beyond mirror-front lamps, including wall-mounted luminaires, ceiling-mounted fixtures, corridor lights, stairway lights, cabinet lights, or other indoor lighting devices requiring uninterrupted illumination capability. Structural arrangements, enclosure shapes, mounting orientations, and optical configurations may vary according to application requirements without departing from the core principles of dual-mode power management and controlled battery usage.

In some embodiments, detection of availability of the household AC power source may be implemented using voltage sensing, current sensing, optically isolated detection circuits, digital sampling through an analog-to-digital converter, or combinations thereof. The detection mechanism may be integrated within the controller, implemented as a discrete detection unit, or distributed across multiple circuit components. Any suitable technique capable of reliably indicating presence or absence of external power may be employed.

In some embodiments, prevention of battery discharge during availability of household AC power may be achieved through electrical isolation, controlled switching elements, power path management circuits, software-controlled gating, or combinations thereof. Battery preservation during normal operation ensures that stored energy remains substantially unused until emergency conditions arise, thereby supporting extended battery availability and reducing degradation caused by unnecessary charge-discharge cycling.

In some embodiments, transition between operating modes may occur automatically without user intervention, and such transition may be substantially instantaneous or may include controlled delay, debounce logic, or state verification to prevent false switching due to transient power fluctuations. The controller may incorporate hysteresis, filtering algorithms, or timing thresholds to improve stability of mode selection.

In some embodiments, the main light source and the auxiliary light source may share physical light-emitting elements, optical components, or light guides while remaining functionally distinct through independent electrical control. Alternatively, the main light source and the auxiliary light source may be physically separate lighting elements optimized for different brightness levels, beam patterns, or operating durations. Any arrangement permitting differentiated power consumption behavior falls within the scope of the disclosed invention.

In some embodiments, sensing functions associated with human presence and ambient light conditions may be implemented using various sensor technologies, including passive infrared sensing, microwave radar sensing, image-based sensing, photodiodes, photoresistors, or integrated multi-sensor modules. Sensor placement, sensitivity settings, and signal processing methods may be adapted to installation environment and user preferences.

In some embodiments, user-operable control elements such as mode switches, dip switches, touch interfaces, remote controls, or wireless interfaces may allow configuration of operating parameters including illumination duration, brightness level, sensor enablement, battery supply level, or battery conditioning behavior. Such configuration options may be fixed at installation, adjustable during use, or dynamically updated through firmware.

In some embodiments, battery monitoring and warning indication functions may provide feedback regarding battery charge level, battery health status, charging state, or fault conditions. Visual indicators, audible indicators, networked notifications, or combinations thereof may be employed to communicate battery-related information to a user, maintenance personnel, or external monitoring systems.

In some embodiments, the third operating mode associated with battery conditioning may be executed periodically, intermittently, or adaptively based on detected battery condition, usage history, environmental factors, or time-based schedules. Battery conditioning strategies may include partial discharge, controlled recharge, balancing operations, or other maintenance techniques suitable for prolonging battery service life while preserving emergency readiness.

In some embodiments, the various features, components, operating modes, and control strategies described herein may be implemented individually or in any suitable combination. Absence or presence of specific optional features does not limit applicability of the underlying inventive concepts. The disclosed embodiments are intended to illustrate representative implementations, and variations, modifications, and equivalents falling within the scope of the appended claims are contemplated as part of the invention.

In some embodiments, the controller may be implemented using a programmable processing unit executing firmware instructions stored in non-volatile memory. Firmware logic may be updated, modified, or customized to alter operating behavior without changing hardware configuration. Such programmability allows adaptation to different regulatory requirements, user habits, or installation environments while maintaining the same underlying power-management architecture.

In some embodiments, power routing between the household AC power source, the battery, and the light source may be implemented using solid-state switching devices, relays, integrated power management integrated circuits, or hybrid arrangements. Selection of specific switching technologies may depend on voltage level, current capacity, efficiency targets, thermal considerations, or cost constraints, without affecting functional operation as defined in the claims.

In some embodiments, the lighting apparatus may include additional protective features such as surge suppression, overvoltage protection, undervoltage protection, short-circuit protection, thermal shutdown, or fault isolation. These protective features may be integrated within existing modules or implemented as separate circuits, enhancing safety and reliability while remaining ancillary to the primary inventive concepts.

In some embodiments, the auxiliary light source may be configured to operate in multiple illumination patterns, brightness gradients, or color outputs depending on detected conditions. For example, illumination intensity may vary based on duration of detected human presence, rate of movement, ambient light trends, or battery charge level. Such adaptive behavior enhances usability while preserving battery resources.

In some embodiments, ambient light thresholds, motion detection sensitivity, delay durations, battery supply levels, and conditioning parameters may be factory-configured, user-configurable, self-learning, or dynamically adjusted by the controller based on historical usage patterns. Adaptive parameter adjustment allows the lighting apparatus to optimize performance over time without requiring manual recalibration.

In some embodiments, the lighting apparatus may communicate operational status, battery condition, or configuration data to external devices through wired interfaces or wireless communication protocols. External devices may include building management systems, mobile devices, or maintenance tools. Communication capability may support monitoring, diagnostics, or remote configuration without limiting standalone operation.

In some embodiments, the battery may be removable, replaceable, or permanently integrated within the lighting apparatus. Battery form factor, capacity, and chemistry may be selected according to expected outage duration, installation constraints, safety standards, or environmental considerations. The disclosed control strategies apply regardless of specific battery implementation.

In some embodiments, multiple lighting apparatuses may be installed within a shared environment and operate independently or cooperatively. Cooperative operation may include staggered activation, load balancing, or coordinated illumination patterns during power outages. Such system-level behavior may be achieved without centralized control, relying instead on identical distributed logic implemented in each lighting apparatus.

In some embodiments, the disclosed lighting apparatus may operate in environments subject to frequent power fluctuations, voltage instability, or intermittent outages. Robust mode detection and battery-preservation strategies ensure reliable illumination under such conditions. The invention is particularly advantageous in regions with unstable power infrastructure or safety-critical lighting requirements.

In some embodiments, the features described in the specification and illustrated in the drawings are provided as examples to facilitate understanding and enable implementation. The invention is not limited to the specific embodiments shown, and modifications, substitutions, rearrangements, and equivalents that achieve substantially similar functions in substantially similar ways fall within the intended scope of protection as defined by the appended claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a rectifier module configured to receive a household AC power source and convert the household AC power source into DC power;
a battery;
a charging module coupled to the rectifier module and the battery;
a light source; and
a controller coupled to the rectifier module, the battery, the charging module, and the light source,
wherein the controller detects availability of the household AC power source and selectively operates the lighting apparatus in a first operating mode when the household AC power source is available and a second operating mode when the household AC power source is unavailable,
wherein in the first operating mode the battery is prevented from supplying power to the light source,
and wherein in the second operating mode the battery supplies power to the light source.

2. The lighting apparatus of claim 1, wherein the light source comprises a main light source and an auxiliary light source.

3. The lighting apparatus of claim 2, wherein in the second operating mode the controller disables the main light source and enables the auxiliary light source.

4. The lighting apparatus of claim 2, wherein the main light source consumes more electrical power than the auxiliary light source.

5. The lighting apparatus of claim 2, wherein in the first operating mode the controller enables the main light source.

6. The lighting apparatus of claim 1, wherein in the first operating mode the charging module charges the battery using power derived from the household AC power source.

7. The lighting apparatus of claim 1, wherein in the first operating mode discharge of the battery is electrically blocked.

8. The lighting apparatus of claim 2, wherein the auxiliary light source provides illumination at a lower brightness level than the main light source.

9. The lighting apparatus of claim 2, further comprising a passive infrared motion sensor coupled to the controller.

10. The lighting apparatus of claim 9, wherein in the second operating mode the controller enables the auxiliary light source only after the passive infrared motion sensor detects human presence.

11. The lighting apparatus of claim 10, wherein the controller turns off the auxiliary light source after expiration of a preset delay following detection of human presence.

12. The lighting apparatus of claim 9, further comprising a light sensor coupled to the controller,
wherein in the second operating mode the controller enables the auxiliary light source only when an ambient light level detected by the light sensor is below a preset threshold and human presence is detected.

13. The lighting apparatus of claim 1, further comprising a user-operable mode switch coupled to the controller.

14. The lighting apparatus of claim 13, wherein the mode switch selects between a first battery supply level and a second battery supply level during the second operating mode.

15. The lighting apparatus of claim 14, wherein the first battery supply level delivers a higher output current than the second battery supply level.

16. The lighting apparatus of claim 14, wherein the second battery supply level is configured to extend operating duration of the battery.

17. The lighting apparatus of claim 1, wherein the controller detects a battery charge level and activates a warning indicator when the battery charge level falls below a preset threshold.

18. The lighting apparatus of claim 17, wherein the warning indicator comprises a visual indicator integrated into the lighting apparatus.

19. The lighting apparatus of claim 1, wherein the controller further operates the lighting apparatus in a third operating mode configured for battery conditioning.

20. The lighting apparatus of claim 19, wherein in the third operating mode the controller partially discharges the battery to no more than half of a rated battery capacity and subsequently recharges the battery to maintain battery health while preserving emergency power availability.
